(19) United States
(12) Patent Application Publication
(10) Pub. No.: US 2010/0040226 A1
(43) Pub. Date: Feb. 18, 2010

(54) DEVICE, PROGRAM AND METHOD FOR GENERATING HASH VALUES

(76) Inventors: Kota IDEGUCHI, Yokohama (JP); Hirotaka YOSHIDA, Yokohama (JP); Toru OWADA, Yokohama (JP)

Correspondence Address: MCDERMOTT WILL & EMERY LLP, 600 13TH STREET, N.W., WASHINGTON, DC, 20005-3096, US

(21) Appl. No.: 12/393,227

(22) Filed: Feb. 26, 2009

(30) Foreign Application Priority Data
Aug. 13, 2008 (JP) 2008-208635

(51) Int. Cl. H04L 9/00; H04K 1/00

(52) U.S. Cl. 380/29

(57) ABSTRACT

The invention aims to provide a hash function whose safety can be evaluated. To achieve this, a message that is input to a message blocking unit 122 is split into multiple message blocks, and shuffled at a shuffling unit 126 using block ciphers per message block from a round key generated at a first round-key generation unit 124 or a second round-key generation unit 125 using a round constant generated at a round-constant generation unit 123. In calculation of the block cipher, particular split data among multiple split data obtained by splitting the blocks are transformed with an F function, and an exclusive disjunction of the transformed data with other particular data is calculated. Using the F function, a transformation including at least a nonlinear transformation is performed more than once.

### INCORPORATION BY REFERENCE

This application claims priority based on a Japanese patent application, No. 2008-208635 filed on Aug. 13, 2008, the entire contents of which are incorporated herein by reference.

### BACKGROUND

The invention relates to techniques for generating hash values.

Hash functions are functions that take messages of any length as their inputs and generate hash values of specific length.

Generally, hash functions are configured with block ciphers that take fixed-length message blocks as their inputs. The functions shuffle the input messages by repeatedly performing block encryption of the messages, and finally output the result as a hash value. Representative examples of hash functions include the SHA-1, as well as members of the SHA-2 hash family such as the SHA-256 (see NIST FIPS 180-2, “Secure Hash Standard”, Aug. 1, 2002 pp. 9-23, http://csrc.nist.gov/publications /fips/fips180-2/fips180-2.pdf, herein referred to as Literature 1).

### SUMMARY OF THE INVENTION

It is known that the SHA-1 described in Literature 1 has certain problems in its collision resistance property, i.e., a safety property which is required nature of hash function. Since the SHA-2 hash family has a structure similar to that of the SHA-1, similar problems related to the safety property as a required nature of hash function might also occur with the SHA-2 family.

Consequently, the present invention provides a hash function whose safety can be evaluated.

To solve the problems described above, the present invention generates hash values using a block cipher that includes a F function which performs nonlinear conversion more than once.

For example, the disclosed system provides hash value generation device which splits the message into blocks of predetermined data length, transforms specific split data by a F function, among a plurality of split data which are generated by splitting the blocks, and generates a hash value of the message by using a block cipher having a shuffling process that calculates an exclusive disjunction between the transformed specific split data and other specific split data, having:

a control unit performing a transformation including at least a nonlinear transformation more than once by the F function.

As described above, the disclosed system can provide a hash function whose safety can be evaluated.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 illustrates a schematic diagram of a hash value generation device according to a first embodiment of the present invention.

FIG. 2 illustrates a schematic diagram showing a linear transformation functions.

FIG. 3 illustrates a schematic diagram of a first key-round-value transformation function ƒₖ.

FIG. 4 illustrates a schematic diagram of a second key-round-value transformation function ƒₖ.

FIG. 5 illustrates a schematic diagram of a plain-text-round-value transformation function ƒ_{R}.

FIG. 6 illustrates a schematic diagram of a computer.

FIG. 7 illustrates a schematic diagram of a hash-value calculation process.

FIG. 8 illustrates a schematic diagram of a process for a first block cipher ƒ_{E}.

FIG. 9 illustrates a schematic diagram of a process for a second block cipher ƒ_{E}.

FIG. 10 illustrates a flowchart showing a hash-value generation process in the hash value generation device.

FIG. 11 illustrates a schematic diagram of a hash value generation device according to a second embodiment of the present invention.

FIG. 12 illustrates a schematic diagram showing a variant of the plain-text-round-value transformation function ƒ_{R}.

FIG. 13 illustrates a schematic diagram showing another variant of the plain-text-round-value transformation function ƒ_{R}.

### DETAILED DESCRIPTION OF THE EMBODIMENTS

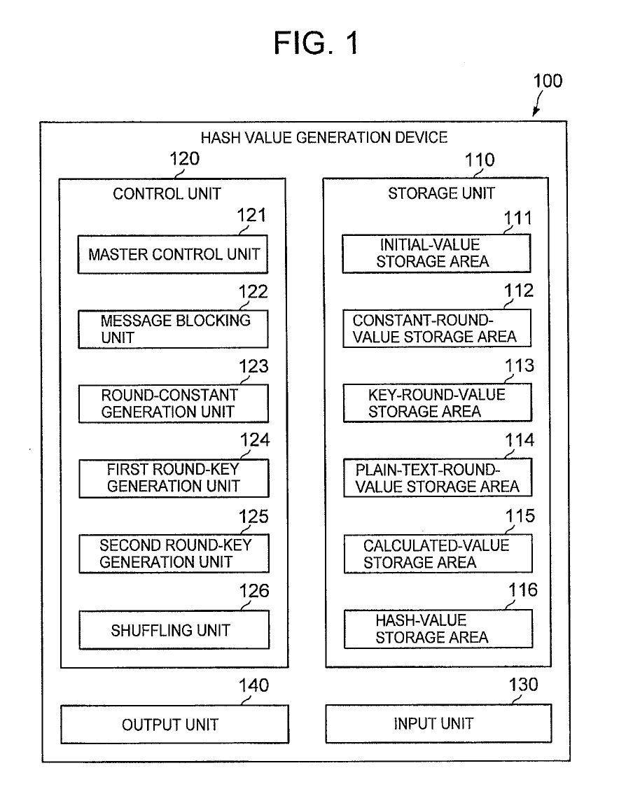

FIG. 1 illustrates a schematic diagram of a hash value generation device 100 in accordance with a first embodiment of the invention.

Note here that in this embodiment, a 512-bit hash value is generated.

As illustrated in FIG. 1, the hash value generation device 100 includes a storage unit 110, a control unit 120, an input unit 130, and an output unit 140.

The storage unit 110 includes an initial-value storage area 111, a constant-round-value storage area 112, a key-round-value storage area 113, a plain-text-round-value storage area 114, a calculated-value storage area 115, and a hash-value storage area 116.

The initial-value storage area 111 stores information specifying an initial value for generating a hash value.

In this embodiment, an initial value of a constant round value and an initial value of a calculated value are stored as initial values for generating a hash value.

Here, as the initial value of the constant round value, a value such as c⁽⁻¹⁾=0xffffffffffffffffffffffffffffffff is stored.

Also, the initial value of the calculated value is H₋₁=(H_{-1.0},H_{-1.1}, . . . ,H_{-1.7}), and constants such as:
H_{-1.0}=0x0000000000000000, H_{-1.1}=0x0000000000000000,
H_{-1.2}=0x0000000000000000, H_{-1.3}=0x0000000000000000,
H_{-1.4}=0x0000000000000000, H_{-1.5}=0x0000000000000000,
H_{-1.6}=0x0000000000000000, H_{-1.7}=0x0000000000000000
   are stored in the value.

Note that the constants used for the initial value of the constant round value and calculated value are not limited to the above, and that it is possible to use random numbers generated by, for example, a pseudorandom number generator or the like.

The constant-round-value storage area 112 stores information identifying a constant round value per round in each message block.

Note that in this embodiment the constant round value is generated in a round-constant generation unit 123 described below.

The key-round-value storage area 113 stores information identifying a key round value per round in each message block.

Note that in this embodiment the key round value is generated in a first round-key generation unit 124 or a second round-key generation unit 125 described below.

The plain-text-round-value storage area 114 stores information identifying a plain-text round value per round in each message block.

Note that in this embodiment the plain-text round value is generated in a shuffling unit 126 described below.

The calculated-value storage area 115 stores information identifying the calculated value which is calculated through all rounds in each message block.

Note that in this embodiment the calculated value is generated in a master control unit 121 described below.

The hash-value storage area stores the hash value calculated through all rounds in all message blocks.

Note that in this embodiment the hash value is generated in the master control unit 121 described below.

The control unit 120 includes the master control unit 121, a message blocking unit 122, the round-constant generation unit 123, the first round-key generation unit 124, the second round-key generation unit 125, and the shuffling unit 126.

The master control unit 121 controls all processes in the hash value generation device 100.

Specifically, in this embodiment, the master control unit 121 conducts a process that manages message blocks obtained by blocking a message for calculating a hash value, and a process that manages rounds in the round-constant generation unit 123, the first round-key generation unit 124, the second round-key generation unit 125, and the shuffling unit 126.

Additionally, the master control unit 121 obtains a calculated value by calculating an exclusive disjunction of a plain-text round value calculated in the shuffling unit 126 through all the rounds and a message block processed in a given round.

Furthermore, the master unit 121 calculates a hash value by calculating an exclusive disjunction of the last message block and a plain-text round value calculated in the shuffling unit 126 through all the message blocks and all the rounds.

The message blocking unit 122 splits a message directed to hash value calculation into blocks of predetermined length and performs padding for the resulting blocks.

Note that although in this embodiment the message directed to hash value calculation is split into 512-bit blocks, the present invention is not limited to such an embodiment.

The padding in this embodiment is performed as described by way of example below.

First, if the number of bits in the message directed to the hash value calculation is divisible by 512 bits, the message blocking unit 122 creates each message block by dividing the message by 512 bits, and adds a message block to create the last message block.

Then, within this last message block, the message blocking unit 122 stores information for specifying “1” in the first bit, “0” in the bits from a bit next to the first bit, the second bit, to the 383rd bit counting from the second bit and the bit length of the message in the last remaining 128 bits.

If the number of bits in the message directed to the hash value calculation is not divisible by 512 bits, the message blocking unit 122 creates each message block by dividing the message by 512 bits, stores information for specifying “0” in all remaining bits in the last split message block to make the length of the block be 512 bits, and further adds a message block to the last split message block to create the last message block.

Then, within this last message block, the message blocking unit 122 stores information for specifying “0” in the bits from the first bit to the 384th bit counting from the first bit, and the bit length of the message in the last 128 bits.

Note that in this embodiment, a message for calculating a hash value is set as M, a message expanded to a length divisible by 512 bits by padding is set as M′, the number of message blocks is set as k+1 (k is an integer greater than or equal to 1), and each message block is set as M′ᵢ (i is an integer where 0=<i=<k).

The round-constant generation unit 123 calculates a constant round value and a round constant in each round.

In this embodiment, the round-constant generation unit 123 uses the linear transformation function ƒ_{c} to calculate the constant round value in each round from the initial value of the constant round value stored in the initial-value storage area 111 in the case of a first round, or from the constant round value of the preceding round stored in the constant-round-value storage area 112 in the cases other than the first round.

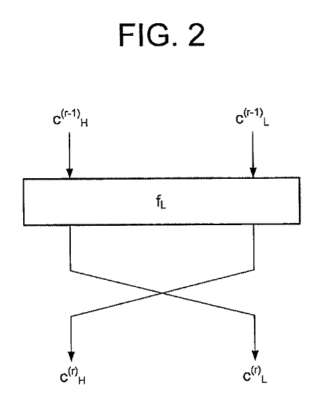

For example, as illustrated in FIG. 2 (which shows a schematic diagram of the linear transformation function ƒ_{c}), the round-constant generation unit 123 calculates the constant round value c^{(r)} of the current round (r) by exchanging the higher-order bits (top 64 bits in this embodiment) with the lower bits (bottom 64 bits in this embodiment) of the value calculated by inputting the constant round value c^{(r-1)} (in the case of r=0, the initial value of the constant round value) of the preceding round (r−1) into the function ƒ_{L}.

That is, the constant round value c^{(r)} of the current round (r) is calculated from the constant round value c^{(r-1)} (in the case of r=0, the initial value of the constant round value) of the preceding round (r−1) as shown in the following formulas (1) and (2).

t_{H}∥t_{L}=ƒ_{L}(c^{(r-1)}) (1)

c^{(r)}=t_{L}∥t_{H} (2)

In the formulas (1) and (2), each of t_{H} and t_{L} is the higher-order bits and the lower bits of the value calculated by inputting the constant round value c^{(r-1)} of the preceding round (r−1) (in the case of r=0, the initial value of the constant round value) into the function ƒ_{L}.

Additionally, the function ƒ_{L} uses a linear feedback shift register (LFSR).

Although the LFSR is typically determined by a polynomial, a polynomial g(x) which determines the LFSR is defined here in the following formula (3).

$$g ( x ) = {x}^{128} + {x}^{126} + {x}^{125} + {x}^{122} + {x}^{121} + {x}^{119} + {x}^{118} + {x}^{117} + {x}^{115} + {x}^{112} + {x}^{110} + {x}^{107} + {x}^{105} + {x}^{104} + {x}^{103} + {x}^{102} + {x}^{100} + {x}^{98} + {x}^{95} + {x}^{94} + {x}^{93} + {x}^{91} + {x}^{90} + {x}^{89} + {x}^{88} + {x}^{87} + {x}^{83} + {x}^{81} + {x}^{77} + {x}^{75} + {x}^{74} + {x}^{69} + {x}^{68} + {x}^{67} + {x}^{65} + {x}^{64} + {x}^{63} + {x}^{59} + {x}^{54} + {x}^{51} + {x}^{50} + {x}^{47} + {x}^{46} + {x}^{45} + {x}^{44} + {x}^{43} + {x}^{41} + {x}^{38} + {x}^{36} + {x}^{35} + {x}^{32} + {x}^{31} + {x}^{30} + {x}^{27} + {x}^{25} + {x}^{21} + {x}^{20} + {x}^{18} + {x}^{13} + {x}^{11} + {x}^{9} + {x}^{8} + {x}^{5} + {x}^{3} + {x}^{2} + {x}^{1} \qquad ( 3 )$$

In the formule, g(x) is a polynomial defined in a finite field GF (2).

Meanwhile, pseudo-codes of the function ƒ_{L} are shown in the following formula (4).

$$\begin{matrix}tmp = ( h >> 63 ) \& 1 ; \\ h = ( h << 1 ) \vert ( l >> 63 ) ; \\ l = l << 1 ; \\ if ( tmp = 1 ) \{ \begin{matrix}{h}^{\hat{}} = 0 \times 66 e 94 bd 4 ef 8 a 2 c 3 b ; \\ {l}^{\hat{}} = 0 \times 884 cfa 59 ca 342 b 2 e ;\end{matrix} \}\end{matrix} \} \qquad ( 4 )$$

In the formula, “<<X” means an X-bit left shift operation, “>>Y” means a Y-bit right shift operation, “̂” means an exclusive disjunction per bit, “&” means a conjunction per bit, and “|” means a disjunction per bit. Also, “h” means the higher-order bits (top 64 bits) in the constant round value c^{(r-1)}, and “l” means the lower-order bits (bottom 64 bits) in the constant round value c^{(r-1)}.

Then, the round-constant generation unit 123 outputs the lower-order 64 bits of the constant round value c^{(r)} at the calculated round (r) to the first round-key generation unit 124 or the second round-key generation unit 125 as the round constant C^{(r)} in the r th round.

An example of C^{(r)} in the case of r=96 will be presented below.
C⁽⁰⁾=0x9916b42b1075d3c4, C⁽¹⁾=0xef660b4c6b97a9a1,
C⁽²⁾=0x645ad0ac41d74f11, C⁽³⁾=0xdb7166e541d48abf,
C⁽⁴⁾=0x81f2b60293356a19, C⁽⁵⁾=0x0b2cd041e8d806c6,
C⁽⁶⁾=0x71ba676d3737d203, C⁽⁷⁾=0x5ac3fe60d882617f,
C⁽⁸⁾=0xd670690748b71e50, C⁽⁹⁾=0x0de6b2578d83a9c6,
C⁽¹⁰⁾=0x495850aeb6b42f1c, C⁽¹¹⁾=0x379ac95e360ea718,
C⁽¹²⁾=0x4388096e355a904b, C⁽¹³⁾=0xa81b9a1fa3d8e607,
C⁽¹⁴⁾=0x1eb9d10b41021771, C⁽¹⁵⁾=0xa06e687e8f63981c,
C⁽¹⁶⁾=0x7ae7442d04085dc5, C⁽¹⁷⁾=0x81b9a1fa3d8e6070,
C⁽¹⁸⁾=0x8d745b60ffab5b2e, C⁽¹⁹⁾=0x7096388fgddbfba6,
C⁽²⁰⁾=0x43a1d2e4854f16df, C⁽²¹⁾=0xd2c1168da307b8c4,
C⁽²²⁾=0x686e0046fab67746, C⁽²³⁾=0x5b9dae851876b54c,
C⁽²⁴⁾=0xc7514acf0553f123, C⁽²⁵⁾=0x7eef4ea7f5b2836d,
C⁽²⁶⁾=0x7bac60e8fac5e8b7, C⁽²⁷⁾=0xeb24ce2c42a25be8,
C⁽²⁸⁾=0x8858c877049d8ee6, C⁽²⁹⁾=0xbc0acc029ee139fd,
C⁽³⁰⁾=0x216321dc12763b99, C⁽³¹⁾=0xf02b300a7b84e7f4,
C⁽³²⁾=0x858c877049d8ee65, C⁽³³⁾=0xa6458bfd0199b3ea,
C⁽³⁴⁾=0x6042a2a65c81c3f2, C⁽³⁵⁾=0xef6690937d84b5cf,
C⁽³⁶⁾=0x91937e2ae66f5995, C⁽³⁷⁾=0xdb7309991998fb06,
C⁽³⁸⁾=0x303d47cce25f1c32, C⁽³⁹⁾=0x7d55d2d7f20bba44,
C⁽⁴⁰⁾=0xc0f51f33897c70c8, C⁽⁴¹⁾=0x93be008b27a4c52a,
C⁽⁴²⁾=0x134d887db199957d, C⁽⁴³⁾=0x4ef8022c9e9314a8,
C⁽⁴⁴⁾=0x4d3621f6c66655f4, C⁽⁴⁵⁾=0x5d09436695c67e9b,
C⁽⁴⁶⁾=0x244173688df1018c, C⁽⁴⁷⁾=0x12cc464eb893d657,
C⁽⁴⁸⁾=0xe77572c54c267c57, C⁽⁴⁹⁾=0x3d41a65d99ad233a,
C⁽⁵⁰⁾=0x8d4c3fa6a4f1a700, C⁽⁵¹⁾=0xf506997666b48ce9,
C⁽⁵²⁾=0x3530fe9a93c69c01, C⁽⁵³⁾=0xb2f32e0d75581f9f,
C⁽⁵⁴⁾=0xa2b3450d34f80a62, C⁽⁵⁵⁾=0xbdbc0752ae82041a,
C⁽⁵⁶⁾=0xfcbdab53a80253ee, C⁽⁵⁷⁾=0x8080a22dc1ea6a0e,
C⁽⁵⁸⁾=0xe26f59fd346119e5, C⁽⁵⁹⁾=0x020288b707a9a839,
C⁽⁶⁰⁾=0xef542c203e0e4baf, C⁽⁶¹⁾=0x7e7a9dbb6544da82,
C⁽⁶²⁾=0xadc944336c5178e0, C⁽⁶³⁾=0x9f033d397a994632,
C⁽⁶⁴⁾=0xc155afaacaa799e6, C⁽⁶⁵⁾=0xa7c4b82918762ae,
C⁽⁶⁶⁾=0x15cf4a18bef631c4, C⁽⁶⁷⁾=0x29f12e0a461d8ab8,
C⁽⁶⁸⁾=0x573d2862fbd8c710, C⁽⁶⁹⁾=0xa7c4b82918762ae0,
C⁽⁷⁰⁾=0x3a1dea5f00e9307a, C⁽⁷¹⁾=0xe9625fc31a3ad1e7,
C⁽⁷²⁾=0x9e07161b7846bb8e, C⁽⁷³⁾=0xb5108bbffc8311c1,
C⁽⁷⁴⁾=0x781c586de11aee39, C⁽⁷⁵⁾=0xd4422efff20c4704,
C⁽⁷⁶⁾=0x86982a636be194de, C⁽⁷⁷⁾=0x41914f4c5c594a4d,
C⁽⁷⁸⁾=0x1a60a98daf865378, C⁽⁷⁹⁾=0x60ac76e59eef050f,
C⁽⁸⁰⁾=0x1ff21951c5fb3787, C⁽⁸¹⁾=0x92282f25efd44260,
C⁽⁸²⁾=0x7fc8654717ecde1d, C⁽⁸³⁾=0x48a0bc97bf510980,
C⁽⁸⁴⁾=0x99c8dec8b039544f, C⁽⁸⁵⁾=0x321b06ed692c705d,
C⁽⁸⁶⁾=0x67237b22c0e5513c, C⁽⁸⁷⁾=0xc86c1bb5a4b1c174,
C⁽⁸⁸⁾=0xfa64a75fec1f68ca, C⁽⁸⁹⁾=0x31299a6506af538d,
C⁽⁹⁰⁾=0x8f7bd6ab5ff78f13, C⁽⁹¹⁾=0xb2d6d6f3615f3452,
C⁽⁹²⁾=0x4b9fe5ca043c462a, C⁽⁹³⁾=0xbd2be4aafe9eab2f,
C⁽⁹⁴⁾=0x3ee6639b84994ef5, C⁽⁹⁵⁾=0xf4af92abfa7aacbc

The first round-key generation unit 124 calculates key round values and round keys in each round.

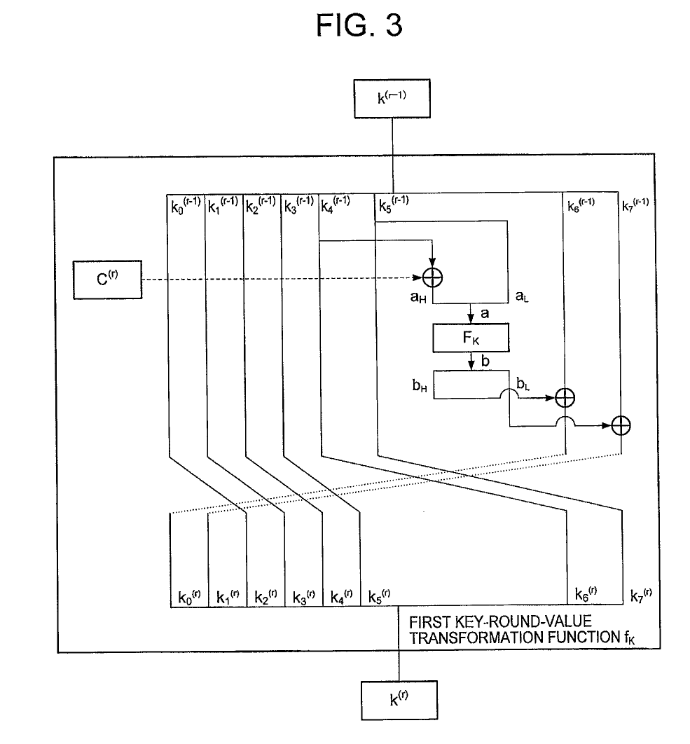

For example, the key round values will be calculated by the first round-key generation unit 124 using the first key-round-value transformation function ƒ_{K} illustrated in FIG. 3 (which shows a schematic diagram of the first key-round-value transformation function ƒ_{K}).

As illustrated, the first key-round-value transformation function ƒ_{K} is a function which creates a key round value k^{(r)} of the rth round by transforming split data k₀^{(r-1)}, k₁^{(r-1)}, k₂^{(r-1)}, k₃^{(r-1)}, k₄^{(r-1)}, k₅^{(r-1)}, k₆^{(r-1)}, k₇^{(r-1)} into k₀^{(r)}, k₁^{(r)}, k₂^{(r)}, k₃^{(r)}, k₄^{(r)}, k₅^{(r)}, k₆^{(r)}, k₇^{(r)} respectively, and then combining those transformed values. The split data k₀^{(r-1)}, k₁^{(r-1)}, k₂^{(r-1)}, k₃^{(r-1)}, k₄^{(r-1)}, k₅^{(r-1)}, k₆^{(r-1)}, k₇^{(r-1)} are created by dividing a key round value k^{(r-1)} of the (r−1) round (in the case of r=0, the calculated value stored in the calculated-value storage area 115, or the initial value of the calculated value stored in the initial-value storage area 111) into 8 values (here, the size of each split data is 64 bits).

Specifically, using the first key-round-value transformation function ƒ_{K}, the first round-key generation unit 124 splits a key round value of the (r−1) round stored in the key-round-value storage area 113 (in the case of r=0, the calculated value stored in the calculated-value storage area 115, or the initial value of the calculated value stored in the initial-value storage area 111) into 8 values k₀^{(r-1)}, k₁^{(r-1)}, k₂^{(r-1)}, k₃^{(r-1)}, k₄^{(r-1)}, k₅^{(r-1)}, k₆^{(r-1)}, k₇^{(r-1)}.

Next, the first round-key generation unit 124 applies k₀^{(r-1)}, k₁^{(r-1)}, k₂^{(r-1)}, k₃^{(r-1)} in the key round value of the (r−1) round to k₂^{(r)}, k₃^{(r)}, k₄^{(r)}, k₅^{(r)} in the key round value of the rth round respectively.

Then, the first round-key generation unit 124 calculates a higher-order bits (here, 64 bits) value b_{H} (b_{H}=F_{K}(k₄^{(r-1)}XOR C^{(r)}, k₅^{(r-1)})_{H}) and a lower bits (here, 64 bits) value b_{L} (b_{L}=F_{K}(k₄^{(r-1)}XOR C^{(r)}, k₅^{(r-1)})_{L}) of the value output by inputting a value a which is generated by combining a value a_{H} of the exclusive disjunction of the round constant C^{(r)} generated at the round-constant generation unit 123 and k₄^{(r-1)} in the round key of the (r−1) round, and a value a_{L} of k₅^{(r-1)} in the round key of the (r−1) round into the function F_{K} which is one of the F functions.

Then, the first round-key generation unit 124 calculates an exclusive disjunction of the values b_{H} and k₆^{(r-1)} in the key round value of the (r−1) round, and takes the calculated value to be the key round value k₀^{(r)} of the rth round.

Additionally, the first round-key generation unit 124 calculates an exclusive disjunction of the values b_{L} and k₇^{(r-1)} in the key round value of the (r−1) round, and takes the calculated value to be the key round value k₁^{(r)} of the rth round.

Then, the first round-key generation unit 124 takes k₄^{(r-1)} and k₅^{(r-1)} in the key round value of the (r−1) round to be the key round values k₆^{(r)} and k₇^{(r)} of the rth round respectively.

Then, the first round-key generation unit 124 combines k₀^{(r)}, k₁^{(r)}, k₂^{(r)}, k₃^{(r)}, k₄^{(r)}, k₅^{(r)}, k₆^{(r)}, and k₇^{(r)} calculated as described above together to generate the key round value of the rth round, replaces the key round value of the (r−1) round with it, and stores it in the key-round-value storage area 113.

Besides, the first round-key generation unit 124 outputs to the shuffling unit 126 k₃^{(r)} in the key round value of the rth round as the round key K^{(r)} of the rth round.

Next, a function F_{K} which is one of the F functions used in the first round-key generation unit 124 will be described.

The function F_{K} is a function which performs a combined transformation of a nonlinear transformation γ_{K} and a linear transformation λ_{K} as expressed in the following formula (5).

F_{K}=(λ_{K}∘γ_{L}) (5)

where the linear transformation λ_{K} is another combined transformation of a byte permutation π_{K} and a matrix multiplication θ_{K}.

In the following, input into the function F_{K} will be described as X, and output from the function F_{K} will be described as Y.

In this embodiment, both X and Y are 128-bit data.

First, the nonlinear transformation γ_{K} splits the value X into sub-data (s₀, s₁, . . . , s₁₅) in which the size of each element is 8 bits, and as expressed in the following formula (6), a nonlinear transformation is performed for each of the split data using a substitution table, S-box, where the transformed sub-data is represented as s′₀, s′₁, . . . , s′₁₅.

s′ᵢ=S(sᵢ), i=0,1, . . . ,15 (6)

Here, the substitution table S-box is defined by way of example in the following formula (7).

Sbox[256]={0x63, 0x7c, 0x77, 0x7b, 0xf2, 0x6b, 0x6f, 0xc5, 0x30, 0x01, 0x67, 0x2b, 0xfe, 0xd7, 0xab, 0x76, 0xca, 0x82, 0xc9, 0x7d, 0xfa, 0x59, 0x47, 0xf0, 0xad, 0xd4, 0xa2, 0xaf, 0x9c, 0xa4, 0x72, 0xc0, 0xb7, 0xfd, 0x93, 0x26, 0x36, 0x3f, 0xf7, 0xcc, 0x34, 0xa5, 0xe5, 0xf1, 0x71, 0xd8, 0x31, 0x15, 0x04, 0xc7, 0x23, 0xc3, 0x18, 0x96, 0x05, 0x9a, 0x07, 0x12, 0x80, 0xe2, 0xeb, 0x27, 0xb2, 0x75, 0x09, 0x83, 0x2c, 0x1a, 0x1b, 0x6e, 0x5a, 0xa0, 0x52, 0x3b, 0xd6, 0xb3, 0x29, 0xe3, 0x2f, 0x84, 0x53, 0xd1, 0x00, 0xed, 0x20, 0xfc, 0xb1, 0x5b, 0x6a, 0xcb, 0xbe, 0x39, 0x4a, 0x4c 0x58, 0xcf, 0xd0, 0xef, 0xaa, 0xfb, 0x43, 0x4d, 0x33, 0x85, 0x45, 0xf9, 0x02, 0x7f, 0x50, 0x3c, 0x9f, 0xa8, 0x51, 0xa3, 0x40, 0x8f, 0x92, 0x9d, 0x38, 0xf5, 0xbc, 0xb6, 0xda, 0x21, 0x10, 0xff, 0xf3, 0xd2, 0xcd, 0x0c, 0x13, 0xec, 0x5f, 0x97, 0x44, 0x17, 0xc4, 0xa7, 0x7e, 0x3d, 0x64, 0x5d, 0x19, 0x73, 0x60, 0x81, 0x4f, 0xdc, 0x22, 0x2a, 0x90, 0x88, 0x46, 0xee, 0xb8, 0x14, 0xde, 0x5e, 0x0b, 0xdb, 0xe0, 0x32, 0x3a, 0x0a, 0x49, 0x06, 0x24, 0x5c, 0xc2, 0xd3, 0xac, 0x62, 0x91, 0x95, 0xe4, 0x79, 0xe7, 0xc8, 0x37, 0x6d, 0x8d, 0xd5, 0x4e, 0xa9, 0x6c, 0x56, 0xf4, 0xea, 0x65, 0x7a, 0xae, 0x08, 0xba, 0x78, 0x5, 0x2e, 0x1c, 0xa6, 0xb4, 0xc6, 0xe8, 0xdd, 0x74, 0x1f, 0x4b, 0xbd, 0x8b, 0x8a, 0x70, 0x3e, 0xb5, 0x66, 0x48, 0x03, 0xf6, 0x0e, 0x61, 0x35, 0x57, 0xb9, 0x86, 0xc1, 0x1d, 0x9e, 0xe1, 0xf8, 0x98, 0x11, 0x69, 0xd9, 0x8e, 0x94, 0x9b, 0x1e, 0x87, 0xe9, 0xce, 0x55, 0x28, 0xdf, 0x8c, 0xa1, 0x89, 0x0d, 0xbf, 0xe6, 0x42, 0x68, 0x41, 0x99, 0x2d, 0x0f, 0xb0, 0x54, 0xbb, 0x16}; (7)

Next, the matrix multiplication θ_{K} performs a transformation by converting the transformed sub-data (s′₀, s′₁, . . . , s′₁₅) from the above nonlinear transformation γ_{K} into a matrix with 8 rows and 2 columns, and by multiplying the matrix with a transformation matrix A as expressed in the following formula (10). The transformed sub-data is represented as s″₀, s″₁, . . . , s″₁₅. The multiplication is done over a finite field GF (2⁸). The finite field GF (2⁸) satisfies the following formulas (8) and (9).

$$\begin{matrix} GF ( {2}^{8} ) = GF ( 2 ) [ x ] \text{/} ( {ϕ}_{s} ( x ) ) & ( 8 ) \\ {ϕ}_{s} = {x}^{s} + {x}^{4} + {x}^{3} + x + 1 = 0 x 11 b & ( 9 ) \\ ( \begin{matrix}{s}_{0}^{″} & {s}_{8}^{″} \\ {s}_{1}^{″} & {s}_{9}^{″} \\ {s}_{2}^{″} & {s}_{10}^{″} \\ {s}_{3}^{″} & {s}_{11}^{″} \\ {s}_{4}^{″} & {s}_{12}^{″} \\ {s}_{5}^{″} & {s}_{13}^{″} \\ {s}_{6}^{″} & {s}_{14}^{″} \\ {s}_{7}^{″} & {s}_{15}^{″}\end{matrix} ) = A \cdot ( \begin{matrix}{s}_{0}^{′} & {s}_{8}^{′} \\ {s}_{1}^{′} & {s}_{9}^{′} \\ {s}_{2}^{′} & {s}_{10}^{′} \\ {s}_{3}^{′} & {s}_{11}^{′} \\ {s}_{4}^{′} & {s}_{12}^{′} \\ {s}_{5}^{′} & {s}_{13}^{′} \\ {s}_{6}^{′} & {s}_{14}^{′} \\ {s}_{7}^{′} & {s}_{15}^{′}\end{matrix} ) \\ A = ( \begin{matrix}0 \times 01 & 0 \times 01 & 0 \times 02 & 0 \times 0 a & 0 \times 09 & 0 \times 08 & 0 \times 01 & 0 \times 04 \\ 0 \times 04 & 0 \times 01 & 0 \times 01 & 0 \times 02 & 0 \times 0 a & 0 \times 09 & 0 \times 08 & 0 \times 01 \\ 0 \times 01 & 0 \times 04 & 0 \times 01 & 0 \times 01 & 0 \times 02 & 0 \times 0 a & 0 \times 09 & 0 \times 08 \\ 0 \times 08 & 0 \times 01 & 0 \times 04 & 0 \times 01 & 0 \times 01 & 0 \times 02 & 0 \times 0 a & 0 \times 09 \\ 0 \times 09 & 0 \times 08 & 0 \times 01 & 0 \times 04 & 0 \times 01 & 0 \times 01 & 0 \times 02 & 0 \times 0 a \\ 0 \times 0 a & 0 \times 09 & 0 \times 08 & 0 \times 01 & 0 \times 04 & 0 \times 01 & 0 \times 01 & 0 \times 02 \\ 0 \times 02 & 0 \times 0 a & 0 \times 09 & 0 \times 08 & 0 \times 01 & 0 \times 04 & 0 \times 01 & 0 \times 01 \\ 0 \times 01 & 0 \times 02 & 0 \times 0 a & 0 \times 09 & 0 \times 08 & 0 \times 01 & 0 \times 04 & 0 \times 01\end{matrix} ) & ( 10 )\end{matrix}$$

Note that any transformation matrix may be used as the transformation matrix A if, defining output columns as the columns of values output by transforming the input columns by the transformation matrix A, there exist 9 or more cells whose value is not “0” in the input columns and output columns.

Next, the byte permutation π_{K} replaces half of the sub-data (s″₀, s″₁, . . . , s″₁₅) transformed by the matrix multiplication θ_{K} as expressed in the following formula (11), where the transformed sub-data is represented as y₀, y₁, . . . , y₁₅.

$$\begin{matrix}{y}_{i} = {s}_{i + s}^{″} , & i = 0 , 1 , 2 , 3 \\ {y}_{i} = {s}_{i - 8}^{″} , & i = 8 , 9 , 10 , 11 \\ {y}_{i} = {s}_{i}^{″} , & i = 4 , 5 , 6 , 7 , 12 , 13 , 14 , 15\end{matrix} \} \qquad ( 11 )$$

Then, the sub-data (y₀, y₁, . . . , y₁₅) calculated as described above is combined as expressed in the following formula (12) to generate the output Y of the function F_{K}.

Y=y₀∥y₁∥y₂∥y₃∥y₄∥y₅∥y₆∥y₇∥y₈∥y₉∥y₁₀∥y₁₁∥y₁₂∥y₁₃∥y₁₄∥y₁₅ (12)

Compared with a function F_{R} described below, the function F_{K} described above produces output in a single process with respect to one input, and thus the complexity of the function F_{K} is relatively low and its implementation can be light-weight.

Back to FIG. 1, the second round-key generation unit 125 calculates key round values and round keys in each round.

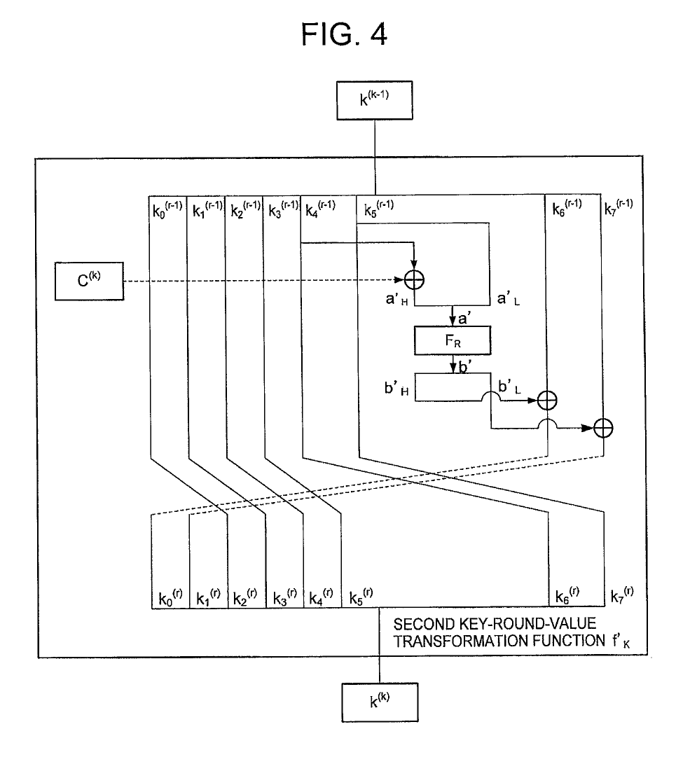

For example, the key round values will be calculated by the second round-key generation unit 125 using the second key-round-value transformation function ƒ′_{K} illustrated in FIG. 4 (which shows a schematic diagram of the first key-round-value transformation function ƒ″_{K}).

As illustrated in FIG. 4, the second key-round-value transformation function ƒ′_{K} is a function which creates a key round value k^{(r)} of the rth round by transforming split data k₀^{(r-1)}, k₁^{(r-1)}, k₂^{(r-1)}, k₃^{(r-1}), k₄^{(r-1)}, k₅^{(r-1)}, k₆^{(r-1)}, k₇^{(r-1)} into k₀^{(r)}, k₁^{(r)}, k₂^{(r)}, k₃^{(r)}, k₄^{(r)}, k₅^{(r)}, k₆^{(r)}, k₇^{(r)} respectively, and then combining those transformed values. The split data k₀^{(r-1)}, k₁^{(r-1)}, k₂^{(r-1)}, k₃^{(r-1)}, k₄^{(r-1)}, k₅^{(r-1)}, k₆^{(r-1)}, k₇^{(r-1)} are created by dividing a key round value k^{(r-1)} of the (r−1) round (in the case of r=0, the calculated value stored in the calculated-value storage area 115, or the initial value of the calculated value stored in the initial-value storage area 111) into 8 values (here, the size of each split data is 64 bits).

Specifically, using the second key-round-value transformation function ƒ′_{K}, the second round-key generation unit 125 splits a key round value of the (r−1) round stored in the key-round-value storage area 113 (in the case of r=0, the calculated value stored in the calculated-value storage area 115) into 8 values k₀^{(r-1)}, k₁^{(r-1)}, k₂^{(r-1)}, k₃^{(r-1)}, k₄^{(r-1)}, k₅^{(r-1)}, k₆^{(r-1)}, k₇^{(r-1)}.

Next, the second round-key generation unit 125 applies k₀^{(r-1)}, k₁^{(r-1)}, k₂^{(r-1)}, k₃^{(r-1)} in the key round value of the (r−1) round to k₂^{(r)}, k₃^{(r)}, k₄^{(r)}, k₅^{(r)} in the key round value of the rth round respectively.

Then, the second round-key generation unit 125 calculates a higher-order bits (here, 64 bits) value b′_{H}(b′_{H}=F_{R}(k₄^{(r-1)}XOR C^{(r)}, k₅^{(r-1)})_{H}) and a lower bits (here, 64 bits) value b′_{L}(b′_{L}=F_{R}(k₄^{(r-1)}XOR C^{(r)}, k₅^{(r-1)})_{H}) of the value output by inputting an value a′ which is generated by combining a value a′_{H} of the exclusive disjunction of the round constant C^{(r)} generated at the round-constant generation unit 123 and k₄^{(r-1)} in the round key of the (r−1) round, and a value a′_{L} of k₅^{(r-1)} in the round key of the (r−1) round into the function F_{R} which is one of the F functions.

Then, the second round-key generation unit 125 calculates an exclusive disjunction of the values b′_{H} and k₆^{(r-1)} in the key round value of the (r−1) round (in the case of r=0, the calculated value), and takes the calculated value to be the key round value k₀^{(r)} of the rth round.

Additionally, the second round-key generation unit 125 calculates an exclusive disjunction of the values b′_{L} and k₇^{(r-1)} in the key round value of the (r−1) round (in the case of =0, the calculated value), and takes the calculated value to be the key round value k₁^{(r)} of the rth round.

Then, the second round-key generation unit 125 takes k₄^{(r-1)} and k₅^{(r-1)} in the key round value of the (r−1) round (in the case of r=0, the calculated value) to be the key round values k₆^{(r)} and k₇^{(r)} of the rth round respectively.

Then, the second round-key generation unit 125 combines k₀^{(r)}, k₁^{(r)}, k₂^{(r)}, k₃^{(r)}, k₄^{(r)}, k₅^{(r)}, k₆^{(r)}, and k₇^{(r)} calculated as described above together to generate the key round value of the rth round, replaces the key round value of the (r−1) round with it, and stores it in the key-round-value storage area 113.

Besides, the second round-key generation unit 125 outputs k₃^{(r)} in the key round value of the rth round to the shuffling unit 126 as the round key K^{(r)} of the rth round.

Next, a function F_{R} which is one of the F functions used in the second round-key generation unit 125 will be described.

The function F_{R} is a function which performs a combined transformation of a nonlinear transformation γ_{R}, a byte permutation π_{R}, and a matrix multiplication θ_{R} for four times (four stages) as expressed in the following formula (13).

F_{R}=(θ_{R}∘π_{R}∘γ_{R})⁴ (13)

In the following, input into the function F_{R} will be described as X, and output from the function will be described as Y. In this embodiment, both X and Y are 128-bit data.

First, the nonlinear transformation γ_{R} splits the value X into sub-data (s₀, s₁, . . . , s₁₅) in which the size of each element is 8 bits, and as expressed in the following formula (14), a nonlinear transformation is performed for each of the split data using a substitution table, S-box, where the transformed sub-data is represented as s′₀, s′₁, . . . , s′₁₅.

sᵢ=S(sᵢ), i=0,1, . . . ,15 (14)

Here, the table expressed in the above formula (7) may be used, for example, as the substitution table S-box.

Next, as expressed in the following formula (15), the byte permutation π_{R} performs a transformation by converting the transformed sub-data (s′₀, s′₁, . . . , s′₁₅) from the above nonlinear transformation γ_{R} into a matrix with 4 rows and 4 columns, and replaces the data such that each row's data contained in each column are placed in different columns respectively. Note that the formula (15) is merely an example, and other replacement schemes may be employed if each row's data contained in each column are placed in different columns in that scheme.

Here, the transformed sub-data is represented as s″₀, s″₁, . . . ,s″₁₅.

$$\begin{matrix}{s}_{i}^{″} = {s}_{i}^{′} , & i = 0 , 4 , 8 , 10 \\ {s}_{i}^{″} = {s}_{i + 4 mod 16}^{′} , & i = 1 , 5 , 9 , 13 \\ {s}_{i}^{″} = {s}_{i + 8 mod 16}^{′} , & i = 2 , 6 , 10 , 14 \\ {s}_{i}^{″} = {s}_{i + 12 mod 16}^{′} , & i = 3 , 7 , 11 , 15\end{matrix} \} \qquad ( 15 )$$

Next, as expressed in the following formula (16), the matrix multiplication θ_{R} performs a transformation by multiplying a matrix with 4 rows and 4 columns whose elements are the sub-data (s″₀, s″₁, . . . , s″₁₅) transformed by the above byte permutation π_{R} with a transformation matrix B over a finite field GF(2⁸), where the transformed sub-data is represented as y₀, y₁, . . . , y₁₅.

$$( \begin{matrix}{y}_{0} & {y}_{4} & {y}_{8} & {y}_{12} \\ {y}_{1} & {y}_{5} & {y}_{9} & {y}_{13} \\ {y}_{2} & {y}_{6} & {y}_{10} & {y}_{14} \\ {y}_{3} & {y}_{7} & {y}_{11} & {y}_{15}\end{matrix} ) = B \cdot ( \begin{matrix}{s}_{0}^{″} & {s}_{4}^{″} & {s}_{8}^{″} & {s}_{12}^{″} \\ {s}_{1}^{″} & {s}_{5}^{″} & {s}_{9}^{″} & {s}_{13}^{″} \\ {s}_{2}^{″} & {s}_{6}^{″} & {s}_{10}^{″} & {s}_{14}^{″} \\ {s}_{3}^{″} & {s}_{7}^{″} & {s}_{11}^{″} & {s}_{15}^{″}\end{matrix} ) \\ B = ( \begin{matrix}0 \times 02 & 0 \times 03 & 0 \times 01 & 0 \times 01 \\ 0 \times 01 & 0 \times 02 & 0 \times 03 & 0 \times 01 \\ 0 \times 01 & 0 \times 01 & 0 \times 02 & 0 \times 03 \\ 0 \times 03 & 0 \times 01 & 0 \times 01 & 0 \times 02\end{matrix} ) \qquad ( 16 )$$

Note that any transformation matrix may be used as the transformation matrix B if, defining output columns as the columns of values output by transforming the input columns by the transformation matrix B, there exist 5 or more cells whose value is not “0” in the input columns and output columns.

Then, the transformation achieved as a result of the nonlinear transformation γ_{R}, the byte permutation π_{R}, and the matrix multiplication θ_{R} is performed 3 more times (for a total of 4 times), with each iteration using the sub-data (y₀, y₁, . . . ,y₁₅) calculated as described above for the sub-data (s₀, s₁, . . . , s₁₅). The sub-data (y₀, y₁, . . . , y₁₅) calculated in this manner is then combined as expressed in the following formula (17) to generate the output Y of the function F_{R}.

Y=y₀∥y₁∥y₂∥y₃∥y₄∥y₅∥y₆∥y₇∥y₈∥y₉∥y₁₀∥y₁₁∥y₁₂∥y₁₃∥y₁₄∥y₁₅ (17)

Compared with the function F_{K} described earlier, the function F_{R} above produces output in four processes with respect to one input, and thus safety can be improved. Note that the number of processes may be arbitrarily modified.

Now, back to FIG. 1, the shuffling unit 126 calculates plain-text round values in each round.

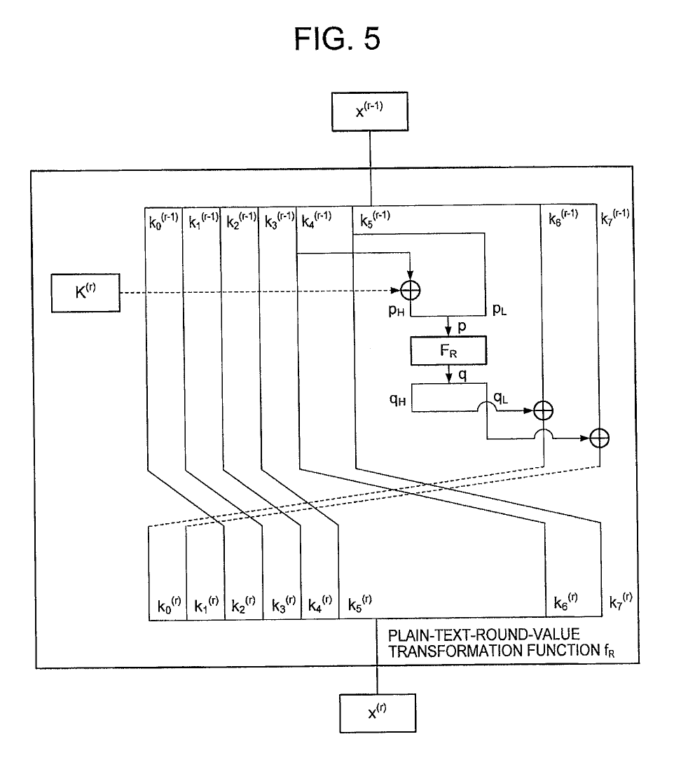

For example, the plain-text round values will be calculated by the shuffling unit 126 using the plain-text-round-value transformation function ƒ_{R} illustrated in FIG. 5 (which shows a schematic diagram of the plain-text-round-value transformation ƒ_{R}).

As illustrated, the plain-text-round-value transformation function ƒ_{R} is a function which creates the plain-text round value x^{(r)} of the rth round by transforming split data x₀^{(r-1)}, x₁^{(r-1)}, x₂^{(r-1)}, x₃^{(r-1)}, x₄^{(r-1)}, x₅^{(r-1)}, x₆^{(r-1)}, x₇^{(r-1)} into x₀^{(r)}, x₁^{(r)}, x₂^{(r)}, x₃^{(r)}, x₄^{(r)}, x₅^{(r)}, x₆^{(r)}, x₇^{(r)} respectively, and then combining those transformed values. The split data x₀^{(r-1)}, x₁^{(r-1)}, x₂^{(r-1)}, x₃^{(r-1)}, x₄^{(r-1)}, x₂^{(r-1)}, x₆^{(r-1)}, x₇^{(r-1)} are created by dividing a plain text value x^{(r-1)} (in the case of r=0, the message block M blocked by the message blocking unit 122) of the (r−1) round into 8 values (here, the size of each split data is 64 bits).

Specifically, using the plain-text-round-value transformation function ƒ_{R}, the shuffling unit 126 first splits a plain-text round value (in the case of r=0, the message block M′ blocked by the message blocking unit 122) of the (r−1) round stored in the plain-text round value storage area 114 into 8 values x₀^{(r-1)}, x₁^{(r-1)}, x₂^{(r-1)}, x₃^{(r-1)}, x₄^{(r-1)}, x₅^{(r-1)}, x₆^{(r-1)}, x₇^{(r-1)}.

Next, the shuffling unit 126 applies x₀^{(r-1)}, x₁^{(r-1)}, x₂^{(r-1)}, x₃^{(r-1)} in the plain-text round value of the (r−1) round (in the case of r=0, the message block M) to x₂^{(r)}, x₃^{(r)}, x₄^{(r)}, x₅^{(r)} in the plain-text round value of the rth round respectively.

Then, the shuffling unit 126 calculates a higher-order bits (here, 64 bits) value q_{H}(q_{H}=F_{R}(x₄^{(r-1)}XOR K^{(r)}, x₅^{(r-1)})_{H}) and a lower bits (here, 64 bits) value q_{L}(q_{L}=F_{R}(x₄^{(r-1)}XOR K^{(r)}, x₅^{(r-1)})_{L}) are calculated from the output value obtained by inputting a value p into the function F_{R} which is one of the F functions. The value p is generated by combining a value p_{H}, the exclusive disjunction of the round constant K^{(r)} generated at the first round-key generation unit 124 or the second round-key generation unit 125 and x₄^{(r-1)} in the plain-text round value of the (r−1) round (in the case of r=0, the message block M′ᵢ), and a value p_{L} of x₅^{(r-1)} in the plain-text round value of the (r−1) round (in the case of r=0, the message block M′ᵢ).

Then, the shuffling unit 126 calculates an exclusive disjunction of q_{H} and x₆^{(r-1)} in the plain-text round value of the (r−1) round (in the case of r=0, the message block M′ᵢ), and takes the calculated value to be the plain-text round value x₀^{(r)} of the rth round.

Additionally, the shuffling unit 126 calculates an exclusive disjunction of a value q_{L} and x₇^{(r-1)} in the plain-text round value of the (r−1) round (in the case of r=0, the message block M′ᵢ), and takes the calculated value to be the plain-text round value x₁^{(r)} of the rth round.

Then, the shuffling unit 126 takes x₄^{(r-1)} and x₅^{(r-1)} in the plain-text round value of the (r−1) round (in the case of r=0, the message block M′ᵢ) to be the plain-text round value x₆^{(r)} and x₇^{(r)} of the rth round respectively.

Then, the shuffling unit 126 combines x₀^{(r-1)}, x₁^{(r)}, x₂^{(r)}, x₃^{(r)}, x₄^{(r)}, x₅^{(r)}, x₆^{(r)}, and x₇^{(r)} calculated as described above together to generate the plain-text round value of the rth round, and replaces the key round value of the (r−1) round with it, and stores it in the plain-text round value storage area 114.

Description of the function F_{R} that is one of the F functions used in the shuffling unit 126 will be omitted, as the definition of the function is similar to the one which is expressed in the above formula (13).

The input unit 130 accepts information input.

The output unit 140 outputs information.

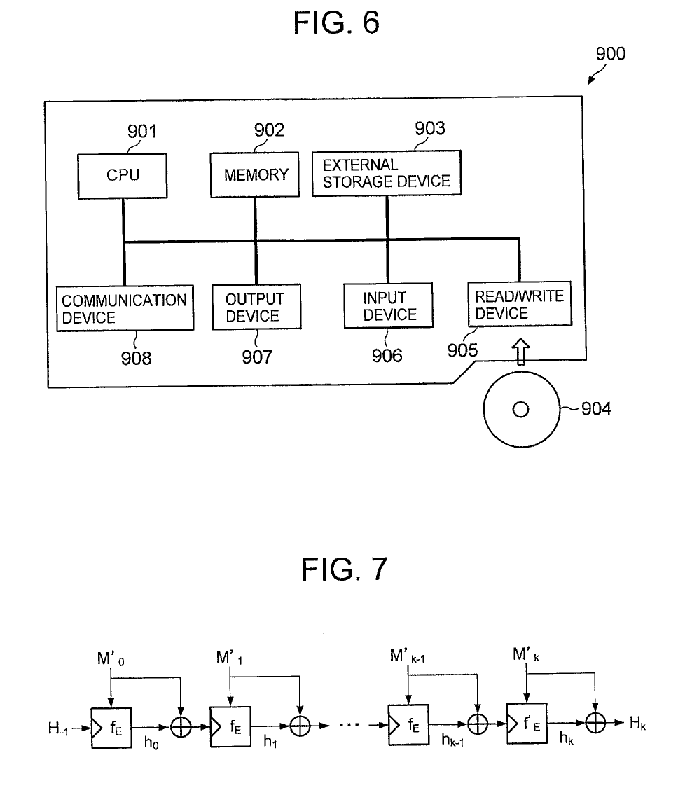

As illustrated in FIG. 6 (which shows a schematic diagram of a general computer 900), the hash value generation device 100 described above can be implemented with, for example, a general computer 900 that includes a Central Processing Unit (CPU) 901, memory 902, an external storage device 903 such as a hard disk drive (HDD) etc., a read/write device 905 which reads/writes information for a portable storage medium 904 such as a Compact Disc Read Only Memory (CD-ROM) or a Digital Versatile Disk Read Only Memory (DVD-ROM), an input device 906 such as a keyboard or a mouse, an output device 907 such as a display, and a communication device 908 such as a Network Interface (NIC) etc. for connecting the computer to a communication network.

For example, the storage unit 10 can be implemented by the CPU 901 utilizing the memory 902 or the external storage device 903, the control unit 120 can be implemented by loading a predetermined program stored in the external storage device 903 into the memory 902 to be executed by the CPU 901, the input unit 130 can be implemented by the CPU 901 utilizing the input device 906, and the output unit 140 can be implemented by the CPU 901 utilizing the output device 907.

The predetermined program may be downloaded into the external storage device 903 from the storage medium 904 via the read/write device 905 or from network via the communication device 908, then loaded into the memory 902 to be executed by the CPU 910. Alternatively, the program may be loaded directly into the memory 902 from the storage medium 904 via the read/write device 905 or from network via the communication device 908 and then executed by the CPU 901.

Next, with reference to FIG. 7 (showing a process for calculating a hash value), an overview of a process in which the hash value generation device 100 calculates a hash value will be described.

First, the hash value generation device 100 accepts input of the message M for generating a hash value via the input unit 130, and the master control unit 121 of the hash value generation device 100 inputs the message M to the message blocking unit 122.

Then, the message blocking unit 122 performs padding for the message M to split the message into message blocks (M′₀, . . . ,M′ₖ: k is an integer greater than or equal to 1) every 512 bits.

Then, the master control unit 121 calculates a plain-text round value h₀ by inputting an initial value H₋₁ of a calculated value stored in the initial-value storage area 111, and a first message block M′₀ of a message block M′ᵢ blocked by the message blocking unit 122 into a first block cipher ƒ_{E}.

Note here that the process using the first block cipher ƒ_{E} is performed at the round-constant generation unit 123, the first round-key generation unit 124, and the shuffling unit 126, as described below.

Then, the master control unit 121 obtains a calculated value by calculating an exclusive disjunction of the calculated plain-text round value h₀ and the message block M′₀, and calculates the plain-text round value h₁ by inputting the calculated value and the next message block M′₁ into the first block cipher ƒ_{E}. Additionally, the calculated value is stored in the calculated-value storage area 115.

These processes are repeated until the message block M′ₖ₋₁ preceding the last message block M′ₖ is used to calculate the plain-text round value hₖ₋₁.

Then, the master control unit 121 calculates the plain-text round value hₖ by inputting the value calculated from an exclusive disjunction of the plain-text round value hₖ₋₁ and the message block M′ₖ₋₁, and the last message block M′ₖ into a second block cipher f′_{E}.

Note here that the process using the second block cipher ƒ′_{E} is performed at the round-constant generation unit 123, the second round-key generation unit 125, and the shuffling unit 126, as described below.

Then, the master control unit 121 calculates a hash value Hₖ from an exclusive disjunction of the plain-text round value hₖ and the last message block M′ₖ.

The hash value Hₖ is stored in the hash-value storage area 116.

Note that the hash value calculation process (method) of the present invention is not limited to the process (method) illustrated in FIG. 7, and that any process (method) may be used if at least one of the first block cipher ƒ_{E} or the second block cipher ƒ′_{E,} is used.

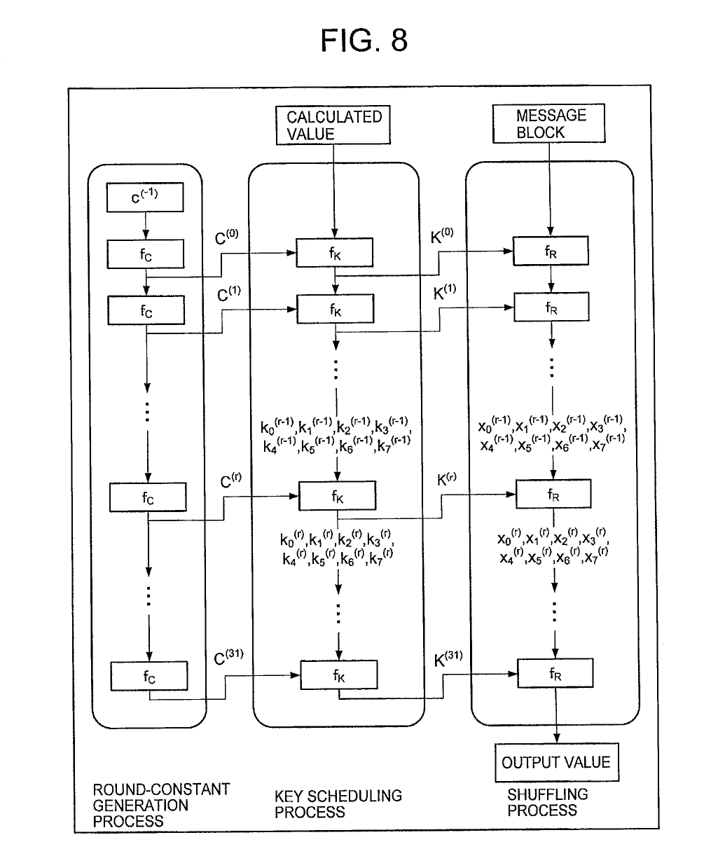

FIG. 8 illustrates a schematic diagram of a process using the first block cipher ƒ_{E}.

First, the round-constant generation unit 123 calculates a constant round value c⁽⁰⁾ of the round r=0 by obtaining an initial value of a constant round value stored in the initial-value storage area 111, and performing a process using a linear transformation function ƒ_{c} such as the one illustrated in FIG. 2. The round-constant generation 123 then calculates the lower 64 bits of the constant round value c⁽⁰⁾ as the round constant C⁽⁰⁾ in the round r=0.

Then, the round-constant generation unit 123 stores the calculated constant round value c⁽⁰⁾ in the constant-round-value storage area 112, and outputs the round constant C⁽⁰⁾ to the first round-key generation unit 124.

Next, if the message block M′ᵢ input into the first block cipher ƒ_{E} is the message block M′₀, the first round-key generation unit 124 obtains the initial value of the calculated value stored in the initial-value storage area 111, while if the message block M′ᵢ input into the first block cipher ƒ_{E} is not the message block M′₀, the first round-key generation unit 124 obtains the calculated value of the preceding message block M′ᵢ stored in the calculated-value storage area 115, calculates a key round value k⁽⁰⁾ in the round r=0 by performing a process using the first key-round-value transformation function ƒ_{K} such as illustrated in FIG. 3, and calculates k₃⁽⁰⁾ in the key round value k⁽⁰⁾ as the round key K⁽⁰⁾ in the round r=0.

Then, the first round-key generation unit 124 stores the key round value k⁽⁰⁾ in the key-round-value storage area 113, and outputs the round key K⁽⁰⁾ to the shuffling unit 126.

Next, the shuffling unit 126 obtains the message block M′ᵢ input into the first block cipher ƒ_{E}, calculates a plain-text round value x⁽⁰⁾ in the round r=0 by performing a process using the plain-text-round-value transformation function ƒ_{R} such as illustrated in FIG. 5, and stores the value in the plain-text round value storage area 114.

With that, the process in the zero round is completed.

Next, the round-constant generation unit 123 calculates a constant round value c⁽¹⁾ of the round r=1 by obtaining the constant round value c⁽⁰⁾ stored in the constant-round-value storage area 112, and performing a process using a linear transformation function ƒ_{c} such as the one illustrated in FIG. 2. The round-constant generation unit 123 then calculates the lower 64 bits of the constant round value c⁽¹⁾ as the round constant C⁽¹⁾ in the round r=1.

Then, the round-constant generation unit 123 replaces (i.e., overwrites) the calculated round value c⁽⁰⁾ with the constant round value c⁽¹⁾, stores it in the constant-round-value storage area 112, and outputs the round constant C⁽¹⁾ to the first round-key generation unit 124.

Next, the first round-key generation unit 124 calculates a key round value k⁽¹⁾ in the round r=1 by obtaining the key round value k⁽⁰⁾ stored in the key-round-value storage area 113, and performing a process using a first key-round-value transformation function ƒ_{K} such as the one illustrated in FIG. 3. The first round-key generation unit 124 then calculates k₃⁽¹⁾ in the key round value k⁽¹⁾ as the round key K⁽¹⁾ in the round r=1.

Then, the first round-key generation unit 124 replaces (i.e., overwrites) the calculated key round value k⁽⁰⁾ with the key round value k⁽¹⁾, stores it in the key-round-value storage area 113, and outputs the round key K⁽¹⁾ to the shuffling unit 126.

Next, the shuffling unit 126 calculates a plain round value x⁽¹⁾ in the round r−1 by obtaining the plain round value x⁽⁰⁾ stored in the plain-text round value storage area 114, and performing a process using a plain-text-round-value transformation function ƒ_{R} such as the one illustrated in FIG. 5. The shuffling unit 126 then replaces (i.e., overwrites) the plain-text round value x⁽⁰⁾ with the calculated plain-text round value x⁽¹⁾, and stores the value in the plain-text round value storage area 114.

With that, the process in the first round is completed.

By repeating processes similar to those in the first round described above until the predetermined round (31st round herein), the whole process for the first block cipher ƒ_{E} is completed.

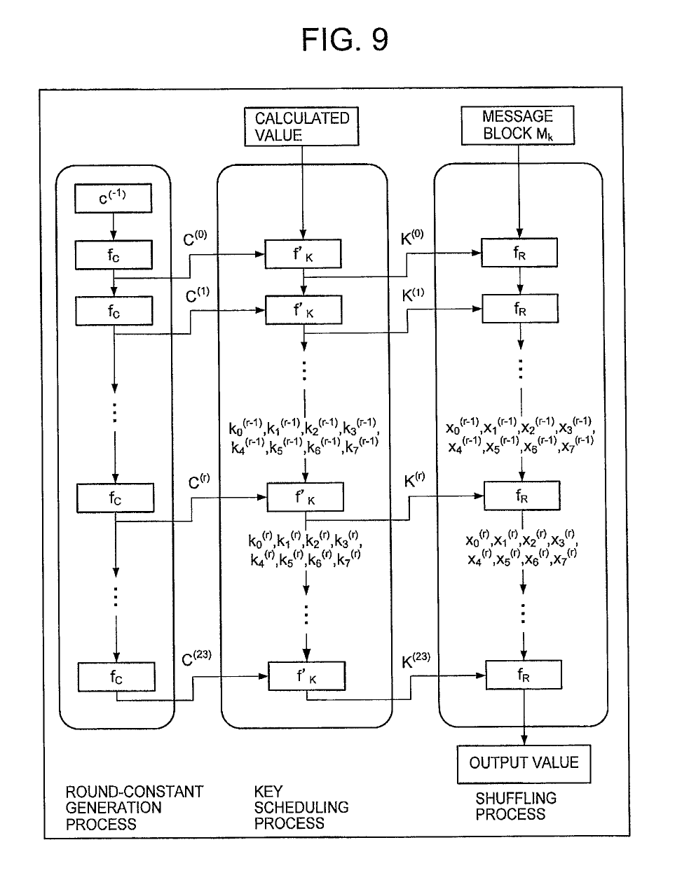

FIG. 9 illustrates a schematic diagram of a process using the second block cipher ƒ_{E}.

First, the round-constant generation unit 123 calculates a constant round value c⁽⁰⁾ of the round r=0 by obtaining an initial value of a constant round value stored in the initial-value storage area 111, and performing a process using a linear transformation function ƒ_{c} such as the one illustrated in FIG. 2. The round-constant generation unit 123 then calculates the lower 64 bits of the constant round value c⁽⁰⁾ as the round constant C⁽⁰⁾ in the round r=0.

Then, the round-constant generation unit 123 stores the calculated constant round value c⁽⁰⁾ in the constant-round-value storage area 112, and outputs the round constant C⁽⁰⁾ to the second round-key generation unit 125.

Next, the second round-key generation unit 125 calculates a constant round value k⁽⁰⁾ of the round r=0 by obtaining a calculated value stored in the preceding message block M′ₖ₋₁ stored in the calculated-value storage area 115, and performing a process using a second key-round-value transformation function ƒ′_{K} such as the one illustrated in FIG. 4. The second round-key generation unit 125 then calculates k₃⁽⁰⁾ in the key round value k⁽⁰⁾ as the round key K⁽⁰⁾ in the round r=0.

Then, the second round-key generation unit 125 stores the key round value k⁽⁰⁾ in the key-round-value storage area 113, and outputs the round key K⁽⁰⁾ to the shuffling unit 126.

Next, the shuffling unit 126 obtains the message block M′ₖ input into the second block cipher ƒ′_{E}, calculates a plain-text round value x⁽⁰⁾ in the round r=0 by performing a process using a plain-text-round-value transformation function ƒ_{R} such as the one illustrated in FIG. 5, and stores the value in the plain-text round value storage area 114.

With that, the process in the zero round is completed.

Next, the round-constant generation unit 123 calculates a constant round value c⁽¹⁾ of the round r=1 by obtaining the constant round value c⁽⁰⁾ stored in the constant-round-value storage area 112, and performing a process using a linear transformation function ƒ_{c} such as the one illustrated in FIG. 2. The round-constant generation unit 123 then calculates the lower 64 bits of the constant round value c⁽¹⁾ as the round constant C⁽¹⁾ in the round r=1.

Then, the round-constant generation unit 123 replaces (i.e., overwrites) the calculated round value c⁽⁰⁾ with the constant round value c⁽¹⁾, stores it in the constant-round-value storage area 112, and outputs the round constant C⁽¹⁾ to the second round-key generation unit 125.

Next, the second round-key generation unit 125 calculates a key round value k⁽¹⁾ in the round r=1 by obtaining the key round value k⁽⁰⁾ stored in the key-round-value storage area 113, and performing a process using a first key-round-value transformation function ƒ′_{K} such as the one illustrated in FIG. 4. The second round-key generation unit 125 then calculates k₃⁽¹⁾ in the key round value k⁽¹⁾ as the round key K⁽¹⁾ in the round r=1.

Then, the second round-key generation unit 125 replaces (i.e., overwrites) the calculated key round value k⁽⁰⁾ with the key round value k⁽¹⁾, stores it in the key-round-value storage area 113, and outputs the round key K⁽¹⁾ to the shuffling unit 126.

Next, the shuffling unit 126 calculates a plain round value x⁽¹⁾ in the round r=1 by obtaining the plain round value x⁽⁰⁾ stored in the plain-text round value storage area 114, and performing a process using a plain-text-round-value transformation function ƒ_{R} such as the one illustrated in FIG. 5. The shuffling unit 126 then replaces (i.e., overwrites) the plain-text round value x⁽⁰⁾ with the calculated plain-text round value x⁽¹⁾, and stores the value in the plain-text round value storage area 114.

With that, the process in the first round is completed.

By repeating processes similar to those in the first round described above until the predetermined round (31st round herein), the whole process for the second block cipher ƒ′_{E} is completed.

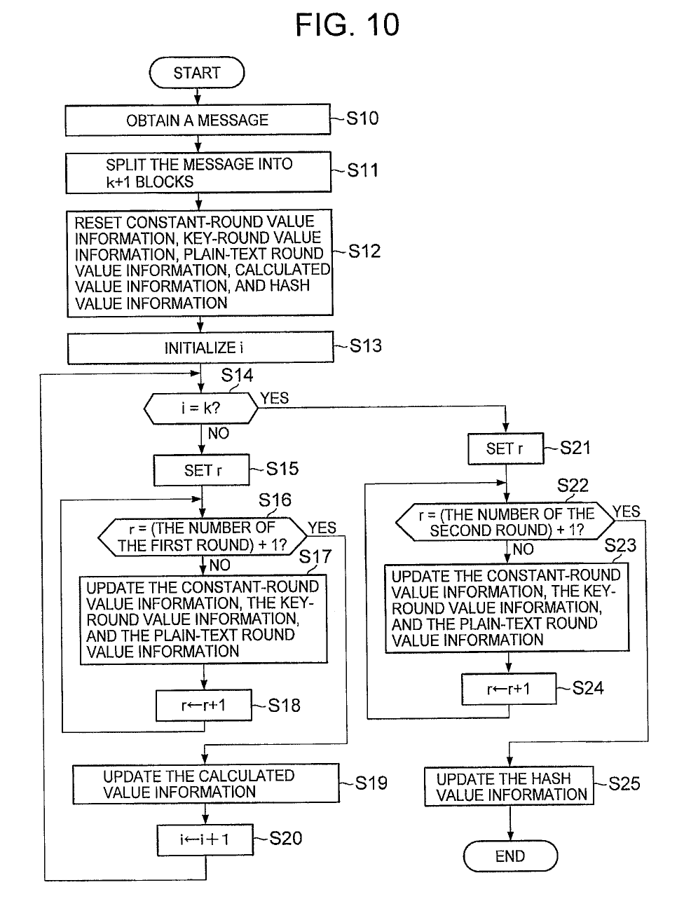

FIG. 10 illustrates a flowchart showing a process for generating a hash value in the hash value generation device 100.

First, the hash value generation device 100 obtains a message M, which is a source for generating a hash value, via the input unit 130 (S10).

Next, the message blocking unit 122 generates k+1 message blocks M′ᵢ by splitting the message obtained via the input unit 130 into blocks of predetermined data length (S11). Note that in this embodiment the message is split into 512-bit data.

Then, the master control unit 121 resets information stored in the constant-round-value storage area 112, the key-round-value storage area 113, the plain-text-round-value storage area 114, the calculated-value storage area 115 and the hash-value storage area 116 (S12). Specifically, all bit values of the information will be reset to “0”.

Next, the master control unit 121 initializes a message counter i that is a counter of the message blocks (S13). At this point, “0” will be assigned as the value of the message counter i.

Then, the master control unit 121 determines whether the value of message counter i satisfies i=k (S14).

In step S14, if i does not equal k (No at step S14), then the process proceeds to step S15, otherwise (Yes at step S14) the process proceeds to step S21.

In step S15, the master control unit 121 assigns an initial value “0” to a round counter r that is a counter of the rounds.

Next, the master control unit 121 determines whether the value of the round counter r has a relationship of r=(ROUND NUM)+1 with the predetermined number of the first round (ROUND NUM=31, herein) (S16). In step S16, if the relationship is satisfied the process proceeds to step S19, otherwise the process proceeds to step S17.

In step S17, a constant round value, a key round value and a plain-text round value are calculated in the round-constant generation unit 123, the first round-key generation unit 124 and the shuffling unit 126 using the first block cipher ƒ_{E}. Additionally, information stored in the constant-round-value storage area 112, the key-round-value storage area 113 and the plain-text-round-value storage area 114 is updated.

Then, the master control unit 121 adds “1” to the value of the round counter r, and goes back to step 16 to repeat the process.

Additionally, in step S19, the master control unit 121 calculates the calculated value by calculating an exclusive disjunction of a plain-text round value stored in the plain-text round value storage area 114 and the message block M′ᵢ, and updates information stored in the calculated-value storage area 115 with the calculated value.

Then, the master control unit 121 adds “1” to the value of the message counter i (S20), and goes back to step 14 to repeat the process.

On the other hand, in step S14, if i=k (Yes at step S14), then in step S21, the master control unit 121 assigns an initial value “0” to the round counter r that is a counter of the rounds.

Next, the master control unit 121 determines whether the value of the round counter r has a relationship of r=(ROUND NUM)+1 with the predetermined number of the second round (ROUND NUM=31, herein) (S22).

Then, in step S22, if the relationship is satisfied (Yes at step S22) the process proceeds to step S25, otherwise (No at step S22) the process proceeds to step S23.

In step S23, a constant round value, a key round value and a plain-text round value are calculated in the round-constant generation unit 123, the second round-key generation unit 125 and the shuffling unit 126 using the second block cipher ƒ′_{E}. Additionally, information stored in the constant-round-value storage area 112, the key-round-value storage area 113 and the plain-text-round-value storage area 114 is updated.

Then, the master control unit 121 adds “1” to the value of the round counter r (S24), and goes back to step 22 to repeat the process.

Additionally, in step S25, the master control unit 121 calculates the calculated value by calculating an exclusive disjunction of a plain-text round value stored in the plain-text round value storage area 114 and the message block M′ₖ, and updates information stored in the calculated-value storage area 116 with the calculated value.

As described above, in this embodiment, a 512-bit block cipher is used so that hash functions can be provided in which theoretical safety and actual safety are ensured.

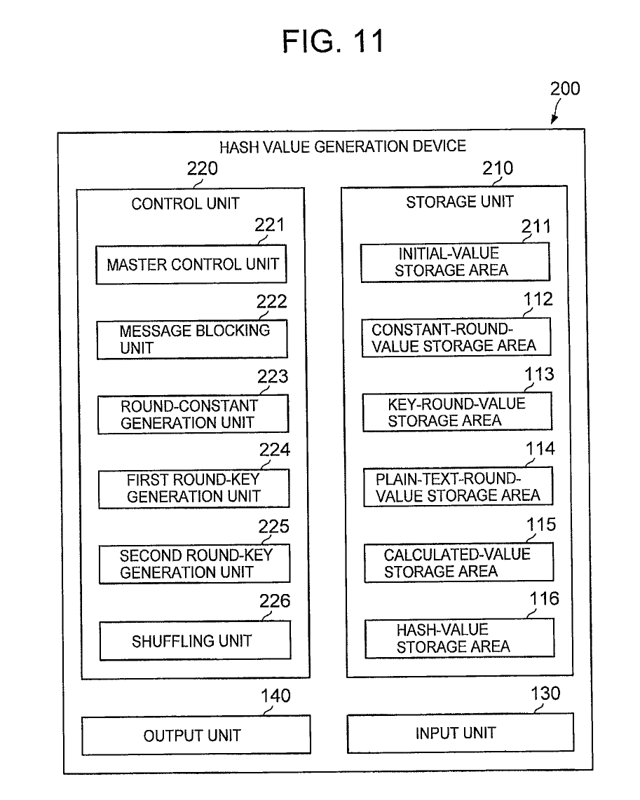

FIG. 11 illustrates a schematic diagram of a hash value generation device 200 in accordance with a second embodiment of the invention.

Note here that in this embodiment a 256-bit hash value is generated.

As illustrated, the hash value generation device 200 includes a storage unit 210, a control unit 220, an input unit 230, and an output unit 240. As compared with the first embodiment, only the configuration of the storage unit 210 and the control unit 220 is different, so aspects associated with the differences will be described below.

The storage unit 210 includes an initial-value storage area 211, a constant-round-value storage area 112, a key-round-value storage area 113, a plain-text-round-value storage area 114, a calculated-value storage area 115 and a hash-value storage area 116. As compared with the first embodiment, information stored in the initial-value storage area 211 is different, so aspects associated with the differences will be described below.

The initial-value storage area 211 stores information which specifies an initial value for generating a hash value.

In this embodiment, an initial value of a constant round value and an initial value of a calculated value are stored as initial values for generating a hash value.

Here, a value such as c⁽⁻¹⁾=0xffffffffffffffff is stored as the initial value of the constant round value.

Also, the initial value of the calculated value is H₋₁=(H_{-1.0},H_{-1.1}, . . . ,H_{-1.7}), and constants such as H_{-1.0}=0x00000000, H_{-1.1}=0x00000000, H_{-1.2}=0x00000000, H_{-1.3}=0x00000000, H_{-1.4}=0x00000000, H_{-1.5}=0x00000000, H_{-1.6}=0x00000000, H_{-1.7}=0x00000000 are stored in the value.

Note that the constants used for the initial value of the constant round value and calculated value are not limited to the above, and that it is possible to use random numbers generated by, for example, a pseudorandom number generator etc.

The control unit 220 includes the master control unit 221, a message blocking unit 222, the round-constant generation unit 223, the first round-key generation unit 224, the second round-key generation unit 225, and the shuffling unit 226.

The master control unit 221 controls all processes in the hash value generation device 200.

Particularly, in this embodiment, the master control unit 221 conducts a process that manages message blocks constructed by blocking a message for calculating a hash value, and a process that manages rounds in the round-constant generation unit 223, the first round-key generation unit 224, the second round-key generation unit 225 and the shuffling unit 226.

Additionally, the master control unit 221 calculates a calculated value by calculating an exclusive disjunction of a plain-text round value calculated in the shuffling unit 226 through all the rounds and a message block processed in a given round.

Furthermore, the master unit 221 calculates a hash value by calculating an exclusive disjunction of the last message block and a plain-text round value calculated in the shuffling unit 226 through all the message blocks and all the rounds.

The message blocking unit 222 splits a message directed to hash value calculation into blocks of predetermined length and performs padding for the resulting blocks.

Note that although in this embodiment the message directed to hash value calculation is split into 256-bit blocks, the present invention is not limited to such an embodiment.

The padding in this embodiment is performed as described by way of example below.

First, if the number of bits in the message directed to the hash value calculation is divisible by 256 bits, the message blocking unit 222 creates each message block by dividing the message by 256 bits, and adds a message block to create the last message block.

Then, within this last message block, the message blocking unit 222 stores “1” in the first bit, “0” in the bits from the second bit to the 191st bit counting from the second bit, and the bit length of the message in the last remaining 64 bits.

If the number of bits in the message directed to the hash value calculation is not divisible by 256 bits, the message blocking unit 222 creates each message block by dividing the message by 256 bits, stores “0” in all remaining bits in the last split message block to make the length of the block be 256 bits, and further adds a message block to the last split message block to create the last message block.

Then, within this last message block, the message blocking unit 222 stores “0” in the bits from the first bit to the 192nd bit counting from the first bit, and the bit length of the message in the last 64 bits.

Note that in this embodiment, we let a message for calculating a hash value be M, a message expanded to a length divisible by 256 bits by padding be M′, the number of message blocks be k+1 (k is an integer greater than or equal to 1), and each message block be M′ᵢ (i is an integer where 0=<i=<k).

The round-constant generation unit 223 calculates a constant round value and a round constant in each round.

Also in this embodiment, the round-constant generation unit 223 uses the linear transformation function ƒ_{c} to calculate the constant round value in each round from the initial value of the constant round value stored in the initial-value storage area 211 in the case of a first round, or from the constant round value of the preceding round stored in the constant-round-value storage area 212 in the cases other than the first round.

For example, as illustrated in FIG. 2, the round-constant generation unit 223 calculates the constant round value c^{(r)} of the current round (r) by exchanging the higher-order bits (32 bits in this embodiment) with the lower bits (32 bits in this embodiment) of the value calculated by inputting the constant round value c^{(r-1)} (in the case of r=0, the initial value of the constant round value) of the preceding round (r−1) into the function ƒ_{L}.

That is, the constant round value c^{(r)} of the current round (r) is calculated from the constant round value c^{(r-1)} (in the case of r=0, the initial value of the constant round value) of the preceding round (r−1) as expressed in the above formulas (1) and (2).

Additionally, the function ƒₛ uses a linear feedback shift register (LFSR). 20 Although the LFSR is typically determined by a polynomial, a polynomial g(x) which determines the LFSR is defined here in the following formula (18).

g(x)=x⁶³+x⁶²+x⁵⁸+x⁵⁵+x⁵⁴+x⁵²+x⁵⁰+x⁴⁹+x⁴⁶+x⁴³+x⁴⁰+x³⁸+x³⁷+x³⁵+x³⁴+x³⁰+x²⁸+x²⁶+x²⁴+x²³+x²²+x¹⁸+x¹⁷+x¹²+x¹¹+x¹⁰+x⁷+x³+x²+x¹ (18)

where g(x) is a polynomial defined in a finite field GF (2).

Meanwhile, pseudo-codes of the function ƒ_{L} are expressed in the following formula (19).

$$\begin{matrix}tmp = ( h >> 31 ) \& 1 ; \\ h = ( h << 1 ) \vert ( l >> 31 ) ; \\ l = l << 1 ; \\ if ( tmp = 1 ) \{ {h}^{\hat{}} = 0 \times c 4 d 6496 c ; {l}^{\hat{}} = 0 \times 55 c 61 c 8 d ; \}\end{matrix} \} \qquad ( 19 )$$

where “<<X” means an X-bit left shift operation, “>>Y” means a Y-bit right shift operation, “̂” means an exclusive disjunction per bit, “&” means a conjunction per bit, and “|” means a disjunction per bit. Also, “h” means the higher-order bits (32 bits) in the constant round value c^{(r-1}), and “l” means the lower bits (32 bits) in the constant round value c^{(r-1)}.

Then, the round-constant generation unit 223 outputs the lower 32 bits of the constant round value c^{(r)} at the calculated round (r) to the first round-key generation unit 224 or the second round-key generation unit 225 as the round constant C^{(r)} in the r th round.

An example of C^{(r)} in the case of r=96 will be presented below.

C⁽⁰⁾=0x3b29b693, C⁽¹⁾=0x90a58f8a, C⁽²⁾=0x472ae357, C⁽³⁾=0x42963e28, C⁽⁴⁾=0xd87dc430, C⁽⁶⁾=0x650288d7, C⁽⁶⁾=0x0ead60b6, C⁽⁷⁾=0xfb50532a, C⁽⁸⁾=0x9139bbc3, C⁽⁹⁾=0x299705c5, C⁽¹⁰⁾=0xef6ad616, C⁽¹¹⁾=0xa65c1715, C⁽¹²⁾=0x797d1135, C⁽¹³⁾=0x32fc654e, C⁽¹⁴⁾=0x21220db8, C⁽¹⁵⁾=0x607dac22, C⁽¹⁶⁾=0x848836e0, C⁽¹⁷⁾=0x4520f9e5, C⁽¹⁸⁾=0xb9ace29a, C⁽¹⁹⁾=0xd055aef9, C⁽²⁰⁾=0x4d3fb373, C⁽²¹⁾=0x8580f288, C⁽²²⁾=0x5ba4bdbb, C⁽²³⁾=0xbd8ff33a, C⁽²⁴⁾=0xaa44bf81, C⁽²⁵⁾=0x5db3f5f3, C⁽²⁶⁾=0xa912fe04, C⁽²⁷⁾=0xb2199ea1, C⁽²⁸⁾=0x0fc7c10b, C⁽²⁹⁾=0xc8667a84, C⁽³⁰⁾=0x3f1f042d, C⁽³¹⁾=0xe54fa37c, C⁽³²⁾=0x57f029af, C⁽³³⁾=0x51e8c49c, C⁽³⁴⁾=0x309ad6ca, C⁽³⁵⁾=0x28f96206, C⁽³⁶⁾=0x69e76232, C⁽³⁷⁾=0xa3e58818, C⁽³⁸⁾=0x634bc1a5, C⁽³⁹⁾=0x241a197a, C⁽⁴⁰⁾=0x49f94ff8, C⁽⁴¹⁾=0x3be45cf2, C⁽⁴²⁾=0xe333768c, C⁽⁴³⁾=0x441d4ad3, C⁽⁴⁴⁾=0x481b935c, C⁽⁴⁵⁾=0x7f2f5b3a, C⁽⁴⁶⁾=0x4f343d06, C⁽⁴⁷⁾=0x93e71c9e, C⁽⁴⁸⁾=0x538a846f, C⁽⁴⁹⁾→0xe4104b62, C⁽⁵⁰⁾=0x8afc58d1, C⁽⁵¹⁾=0xff1b5dff, C⁽⁵²⁾=0x807d5a5f, C⁽⁵³⁾=0x38bb3e91, C⁽⁵⁴⁾=0xaa795066, C⁽⁵⁵⁾=0xe2ecfa45, C⁽⁵⁶⁾=0xa9e54199, C⁽⁵⁷⁾=0x4f65a079, C⁽⁵⁸⁾=0x0c193f7e, C⁽⁵⁹⁾=0xf940c888, C⁽⁶⁰⁾=0x9be8c4e3, C⁽⁶¹⁾=0x21d56b4d, C⁽⁶²⁾=0xc42f2a96, C⁽⁶³⁾=0x8755ad35, C⁽⁶⁴⁾=0xd46ae335, C⁽⁶⁵⁾=0xb6da8dcf, C⁽⁶⁶⁾=0x957dc5b9, C⁽⁶⁷⁾=0x70e60e27, C⁽⁶⁸⁾=0x55f716e4, C⁽⁶⁹⁾=0x074e71f0, C⁽⁷⁰⁾=0x38862be6, C⁽⁷¹⁾=0xb6b5feda, C⁽⁷²⁾=0xe218af99, C⁽⁷³⁾=0xdad7fb69, C⁽⁷⁴⁾=0x4cb4f709, C⁽⁷⁵⁾=0x04059dd2, C⁽⁷⁶⁾=0x5d89ac52, C⁽⁷⁷⁾=0xbb9a4e52, C⁽⁷⁸⁾=0xb2f0f825, C⁽⁷⁹⁾=0x45e50053, C⁽⁸⁰⁾=0xcbc3e094, C⁽⁸¹⁾=0xd3424821, C⁽⁸²⁾=0x4055f227, C⁽⁸³⁾=0x225350f2, C⁽⁸⁴⁾=0x6e0db8ea, C⁽⁸⁵⁾=0x22c17ad2, C⁽⁸⁶⁾=0x7ce0aac4, C⁽⁸⁷⁾=0x2089d252, C⁽⁸⁸⁾=0x3754e27c, C⁽⁸⁹⁾=0x29ab7052, C⁽⁹⁰⁾=0xdd5389f0, C⁽⁹¹⁾=0xa6adc149, C⁽⁹²⁾=0xb1986ead, C⁽⁹³⁾=0x313b3c3f, C⁽⁹⁴⁾=0xc661bab4, C⁽⁹⁵⁾=0x4ecf0fd.

The first round-key generation unit 224 calculates key round values and round keys in each round.

For example, the key round values will be calculated by the first round-key generation unit 224 using the first key-round-value transformation function ƒ_{K} illustrated above in FIG. 3.

As illustrated in FIG. 3, the first key-round-value transformation function ƒ_{K} is a function which creates a key round value k^{(r)} of the rth round by transforming split data k₀^{(r-1)}, k₁^{(r-1)}, k₂^{(r-1)}, k₃^{(r-1)}, k₄^{(r-1)}, k₅^{(r-1)}, k₆^{(r-1)}, k₇^{(r-1)} into k₀^{(r)}, k₁^{(r)}, k₂^{(r)}, k₃^{(r)}, k₄^{(r)}, k₅^{(r)}, k₆^{(r)}, k₇^{(r)} respectively, and then combining those transformed values. The split data k₀^{(r-1)}, k₁^{(r-1)}, k₂^{(r-1)}, k₃^{(r-1)}, k₄^{(r-1}), k₅^{(r-1)}, k₆^{(r-1)}, k₇^{(r-1)} are created by dividing a key round value k^{(k-1)} of the (r−1) round (in the case of r=0, the calculated value stored in the calculated-value storage area 115, or the initial value of the calculated value stored in the initial-value storage area 211) into 8 values (here, the size of each split data is 32 bits).

Note that as the process using the first key-round-value transformation function ƒ_{K} is same as those of the first embodiment except that the bit counts in each process is different, the detailed description thereof will be omitted.

Next, a function F_{K} which is one of the F functions used in the first round-key generation unit 224 will be described.

The function F_{K} in this embodiment is also a function which performs a combined transformation of a nonlinear transformation γ_{K} and a linear transformation λ_{K} as expressed in the above formula (5). The linear transformation λ_{K} is composed of a byte permutation π_{K} and a matrix multiplication θ_{K}.

In the following, input into the function F_{K} will be described as X, and output from the function will be described as Y.

In this embodiment, both X and Y are 64-bit data.

First, the nonlinear transformation γ_{K} splits the value X into sub-data (s₀, s₁, . . . , s₇) in which the size of each element is 8 bits, and as expressed in the following formula (20), a nonlinear transformation is performed for each of the split data using a substitution table, S-box, where the transformed sub-data is represented as s′₀, s′₁, . . . s′₇.

s′ᵢ=S(sᵢ), i=0,1, . . . ,7 (20)

Here, the substitution table S-box is defined by way of example in the above formula (7).

Next, the matrix multiplication θ_{K} performs a transformation by converting the transformed sub-data (s′₀, s′₁, . . . , s′₇) from the above nonlinear transformation γ_{K} into a matrix with 4 rows and 2 columns, and by multiplying the matrix with a transformation matrix A over a finite field GF (2⁸) as expressed in the following formula (21). The transformed sub-data is represented as s″₀, s″₁, . . . , s″₇.

$$( \begin{matrix}{s}_{0}^{″} & {s}_{4}^{″} \\ {s}_{1}^{″} & {s}_{5}^{″} \\ {s}_{2}^{″} & {s}_{6}^{″} \\ {s}_{3}^{″} & {s}_{7}^{″}\end{matrix} ) = A \cdot ( \begin{matrix}{s}_{0}^{′} & {s}_{4}^{′} \\ {s}_{1}^{′} & {s}_{5}^{′} \\ {s}_{2}^{1} & {s}_{6}^{′} \\ {s}_{3}^{′} & {s}_{7}^{′}\end{matrix} ) \\ A = ( \begin{matrix}0 \times 02 & 0 \times 03 & 0 \times 01 & 0 \times 01 \\ 0 \times 01 & 0 \times 02 & 0 \times 03 & 0 \times 01 \\ 0 \times 01 & 0 \times 01 & 0 \times 02 & 0 \times 03 \\ 0 \times 03 & 0 \times 01 & 0 \times 01 & 0 \times 02\end{matrix} ) \qquad ( 21 )$$

Note that any transformation matrix may be used as the transformation matrix A if, defining output columns as the columns of values output by transforming the input columns by the transformation matrix A, there exist 5 or more cells whose value is not “0” n the input columns and output columns.

Next, the byte permutation π_{K} replaces half of the sub-data (s″₀, s″₁, . . . , s″₇) transformed by the matrix multiplication θ_{K} as expressed in the following formula (22), where the transformed sub-data is represented as y₀, y₁, . . . , y₇.

$$\begin{matrix}{y}_{i} = {s}_{i + 4}^{″} , & i = 0 , 1 \\ {y}_{i} = {s}_{i - 4}^{″} , & i = 4 , 5 \\ {y}_{i} = {s}_{i}^{″} , & i = 2 , 3 , 6 , 7\end{matrix} \} \qquad ( 22 )$$

Then, the sub-data (y₀, y₁, . . . , y₇) calculated as described above is combined as expressed in the following formula (23) to generate the output Y of the function F_{K}.

Y=y₀∥y₁∥y₂∥y₃∥y₄∥y₅∥y₆∥y₇ (23)

Compared with a function F_{R} described below, the function F_{K} described above produces output in a single process with respect to one input, and thus the complexity of the function F_{K} is relatively low and its implementation can be light-weight.

Back to FIG. 11, the second round-key generation unit 225 calculates key round values and round keys in each round.

For example, the key round values will be calculated by the second round-key generation unit 225 using a second key-round-value transformation function ƒ′_{K} such as the one illustrated in FIG. 4.

As illustrated in FIG. 4, the second key-round-value transformation function ƒ′_{K} is a function which creates a key round value k^{(r)} of the rth round by transforming split data k₀^{(r-1)}, k₁^{(r-1)}, k₂^{(r-1)}, k₃^{(r-1)}, k₄^{(r-1)}, k₅^{(r-1)}, k₆^{(r-1)}, k₇^{(r-1)} into k₀^{(r)}, k₁^{(r)}, k₂^{(r)}, k₃^{(r)}, k₄^{(r)}, k₅^{(r)}, k₆^{(r)}, k₇^{(r)} respectively, and then combining those transformed values. The split data k₀^{(r-1)}, k₁^{(r-1)}, k₂^{(r-1)}, k₃^{(r-1)}, k₄^{(r-1)}, k₅^{(r-1)}, k₆^{(r-1)}, k₇^{(r-1)} are created by dividing a key round value k^{(r-1)} of the (r−1) round (in the case of r=0, the calculated value stored in the calculated-value storage area 115, or the initial value of the calculated value stored in the initial-value storage area 211) into 8 values (here, the size of each split data is 32 bits).

Note that as the process using the second key-round-value transformation function ƒ′_{K} is same as those of the first embodiment except that the bit counts in each process are different, the detailed description thereof will be omitted.

Next, a function F_{R} which is one of the F functions used in the second round-key generation unit 225 will be described.

The function F_{R} is a function which performs a combined transformation of a nonlinear transformation γ_{R}, a byte permutation π_{R}, and a matrix multiplication θ_{R} for four times (four stages) as expressed in the above formula (13).

In the following, input into the function F_{R} will be described as X, and output from the function will be described as Y.

In this embodiment, both X and Y are 64-bit data.

First, the nonlinear transformation γ_{R} splits the value X into sub-data (s₀, s₁, . . . , s₇) in which the size of each element is 8 bits, and as expressed in the following formula (24), a nonlinear transformation is performed for each of the split data using a substitution table, S-box, where the transformed sub-data is represented as s′₀, s′₁, . . . , s′₇.

s′ᵢ=S(sᵢ), i=0,1, . . . ,7 (24)

Here, the table expressed in the above formula (7) may be used, for example, as the substitution table S-box.

Next, as expressed in the following formula (25), the byte permutation π_{R} performs a transformation by converting the transformed sub-data (s′₀, s′₁, . . . , s′₇) from the above nonlinear transformation γ_{R} into a matrix with 2 rows and 4 columns, and replaces the data such that each row's data contained in each column are placed in different columns respectively. Note that the formula (25) is merely an example, and other replacement schemes may be employed if each row's data contained in each column are placed in different columns in that scheme.

Here, the transformed sub-data is represented as s″₀, s″₁, . . . , s″₇.

$$\begin{matrix}{s}_{i}^{″} = {s}_{i}^{′} , & i = 0 , 2 , 4 , 6 \\ {s}_{i}^{″} = {s}_{i + 2 mod 8}^{′} , & i = 1 , 3 , 5 , 7\end{matrix} \} \qquad ( 25 )$$

Next, as expressed in the following formula (26), the matrix multiplication θ_{R} performs a transformation by multiplying a matrix with 2 rows and 4 columns whose elements are the sub-data (s″₀, s″₁, . . . , s″₇) transformed by the above byte permutation π_{R} with a transformation matrix B over a finite field GF(2⁸), where the transformed sub-data is represented y₀, y₁, . . . , y₇.

$$( \begin{matrix}{y}_{0} & {y}_{2} & {y}_{4} & {y}_{6} \\ {y}_{1} & {y}_{3} & {y}_{5} & {y}_{7}\end{matrix} ) = B \cdot ( \begin{matrix}{s}_{0}^{″} & {s}_{2}^{″} & {s}_{4}^{″} & {s}_{6}^{″} \\ {s}_{1}^{″} & {s}_{3}^{″} & {s}_{5}^{″} & {s}_{7}^{″}\end{matrix} ) \\ B = ( \begin{matrix}0 \times 02 & 0 \times 01 \\ 0 \times 01 & 0 \times 02\end{matrix} ) \qquad ( 26 )$$

Note that any transformation matrix may be used as the transformation matrix B if, defining output columns as the columns of values output by transforming the input columns by the transformation matrix B, there exist 3 or more cells whose value is not “0” in the input columns and output columns.

Then, the transformation achieved as a result of the nonlinear transformation γ_{R}, the byte permutation π_{R}, and the matrix multiplication θ_{R} is performed 3 more times (for a total of 4 times), with each iteration using the sub-data (y₀, y₁, . . . ,y₇) calculated as described above for the sub-data (s₀, s₁, . . . , s₇). The sub-data (y₀, y₁, . . . ,y₇) calculated in this manner is then combined as expressed in the following formula (27) to generate the output Y of the function F_{R}.

Y=y₀∥y₁∥y₂∥y₃∥y₄∥y₅∥y₆∥y₇ (27)

Compared with the function F_{K} described earlier, the function F_{R} above produces output in four processes with respect to one input, and thus safety can be improved. Note that the number of processes may be arbitrarily modified.

Now, back to FIG. 11, the shuffling unit 226 calculates plain-text round values in each round.

For example, the plain-text round values will be calculated by the shuffling unit 226 using the plain-text-round-value transformation function ƒr illustrated in FIG. 5.

As illustrated in FIG. 5, the plain-text-round-value transformation function ƒ_{R} is a function which creates the plain-text round value x^{(r)} of the rth round by transforming split data x₀^{(r-1)}, x₁^{(r-1)}, x₂^{(r-1)}, x₃^{(r-1)}, x₄^{(r-1)}, x₅^{(r-1)}, x₆^{(r-1)}, x₇^{(r-1)} into x₀^{(r)}, x₁⁽¹⁾, x₂^{(r)}, x₃^{(r)}, x₄^{(r)}, x₅^{(r)}, x₆^{(r)}, x₇^{(r)} respectively, and then combining those transformed values. The split data x₀^{(r-1)}, x₁^{(r-1)}, x₂^{(r-1)}, x₃^{(r-1)}, x₄^{(r-1)}, x₅^{(r-1)}, x₆^{(r-1)}, x₇^{(r-1)} are created by dividing a plain text value x^{(r-1)} (in the case of r=0, the message block M′ᵢ blocked by the message blocking unit 222) of the (r−1) round into 8 values (here, (here, the size of each split data is 32 bits).

Note that as the processes using the plain-text-round-value transformation function F_{R} are the same as those of the first embodiment except that the bit counts in each process is different, the detailed description thereof will be omitted.

Also, as the function F_{R} that is one of the F functions used in the shuffling unit 226 is same as the function F_{R} used in the second round-key generation unit 225 described above, the detailed description thereof will be omitted.

The hash value calculation process in this embodiment can be performed in the same way as the one shown in FIG. 7.

First, the hash value generation device 200 accepts input of the message M for generating a hash value via the input unit 130, and the master control unit 221 of the hash value generation device 200 inputs the message M to the message blocking unit 222.

Then, the message blocking unit 222 performs padding for the message M to split the message into message blocks (M′₀, . . . ,M′ₖ: k is an integer greater than or equal to 1) every 256 bits.

Then, the master control unit 221 calculates a plain-text round value h₀ by inputting an initial value H₋₁ of a calculated value stored in the initial-value storage area 211, and a first message block M′₀ of a message block M′ᵢ blocked by the message blocking unit 222 into a first block cipher ƒ_{E}.

Note here that the process using the first block cipher ƒ_{E} is performed at the round-constant generation unit 223, the first round-key generation unit 224, and the shuffling unit 226.

Then, the master control unit 221 obtains a calculated value by calculating an exclusive disjunction of the calculated plain-text round value h₀ and the message block M′₀, and calculates the plain-text round value h₁ by inputting the calculated value and the next message block M′₁ into the first block cipher ƒ_{E}. Additionally, the calculated value is stored in the calculated-value storage area 115.

These processes are repeated until the message block M′ₖ₋₁ preceding the last message block M′ₖ is used to calculate the plain-text round value hₖ₋₁.

Then, the master control unit 221 calculates the plain-text round value hₖ by inputting the value calculated from an exclusive disjunction of the plain-text round value hₖ₋₁ and the message block M′ₖ₋₁, and the last message block M′ₖ into a second block cipher f′_{E.}

Note here that the process using the second block cipher ƒ′_{E} is performed at the round-constant generation unit 223, the second round-key generation unit 225, and the shuffling unit 226.

Then, the master control unit 221 calculates a hash value Hₖ from an exclusive disjunction of the plain-text round value hₖ and the last message block M′ₖ.

The hash value Hₖ is stored in the hash-value storage area 216.

Here, as processes using the first block cipher ƒ_{E} and those using the second block cipher ƒ′_{E} are the same as those shown in FIG. 8 and FIG. 9 except that the bit counts in each process are different, the detailed description thereof will be omitted.

As described above, it can be understood that a 256-bit hash value can be calculated in accordance with this embodiment.

Here, a tolerance indicator using the minimum active S-box number as shown in the following formula (28) can be used against differential attacks and linear attacks.

(Minimum active S-box)*(Differential characteristics of S-box)>block length (28)

In this respect, for the Advanced Encryption Standard (AES) type of F function, letting B be an active S-box number for two stages, the active S-box number for four stages will be B². This method that enhances safety by overlaying S-boxes for four stages in this manner is referred to as the Wide Trail Strategy (WTS).

In contrast, for example, a Feistel structure such as the one illustrated in FIG. 5 involves a process that adds the output of an F function to X₆^{(r-1)} and X₇^{(r-1)}, so it cannot employ the WTS, which simply increases the stages of the F function.

In that respect, the present invention ensures hash safety by performing a combined transformation of a nonlinear transformation γ_{R}, a byte permutation π_{R}, and a matrix multiplication θ_{R} for four times (four stages) in a plain-text-round-value transformation function ƒ_{R}.

For example, for the hash value generation device 100 generating a 512-bit hash value in the first embodiment of the present invention, the minimum active S-box number for two stages is B=5, so the minimum active S-box number per one F function will be B²=25.

Additionally, as there exist at least five active F functions for twelve stages, the minimum value of the active S-box number will be 5*25=125.

Therefore, as the maximum differential propagation probability is 125*6(=750)>512, it can be understood that the formula (28) is satisfied and the embodiment has tolerance against differential attacks.

Additionally, for the hash value generation device 200 generating a 256-bit hash value in the second embodiment of the present invention, the minimum active S-box number for two stages is B=3, so the minimum active S-box number per one F function will be B²=9.

In addition, as there exist at least five active F functions for twelve stages, the minimum value of the active S-box number will be 5*9=45.

Therefore, as the maximum differential propagation probability is 45*6(=270)>256, it can be understood that the formula (28) is satisfied and the embodiment has tolerance against differential attacks.

Note that the WTS is described in detail in J. Daemen and V. Rijmen, Springer, February, 2002, “The Design of Rijndael”, pp. 123-147 (Literature 2).

Also, although 512-bit and 256-bit hash values are calculated in the first embodiment and the second embodiment described above respectively, the present invention is not limited to these aspects, and hash values of other bit lengths such as 224-bit, 384-bit etc. may be calculated by changing the bit length appropriately.

Furthermore, in the embodiments described above, although the hash value generation device 100 and 200 can be implemented with the computer 900 illustrated in FIG. 6, the present invention is not limited to these aspects and may be implemented with various small-scale devices such as non-touch type IC cards, product tags, or a mobile phone handset provided with a CPU and volatile or non-volatile memory.

Additionally, the hash value generation device 100 and 200 need not be implemented by a computer executing programs. For example, the devices may be executed as hardware by integrated logic arrays such as an Application Specific Integrated Circuit (ASIC) or a Field Programmable Gate Array (FPGA), or executed as software by processors such as a Digital Signal Processor (DSP) etc.

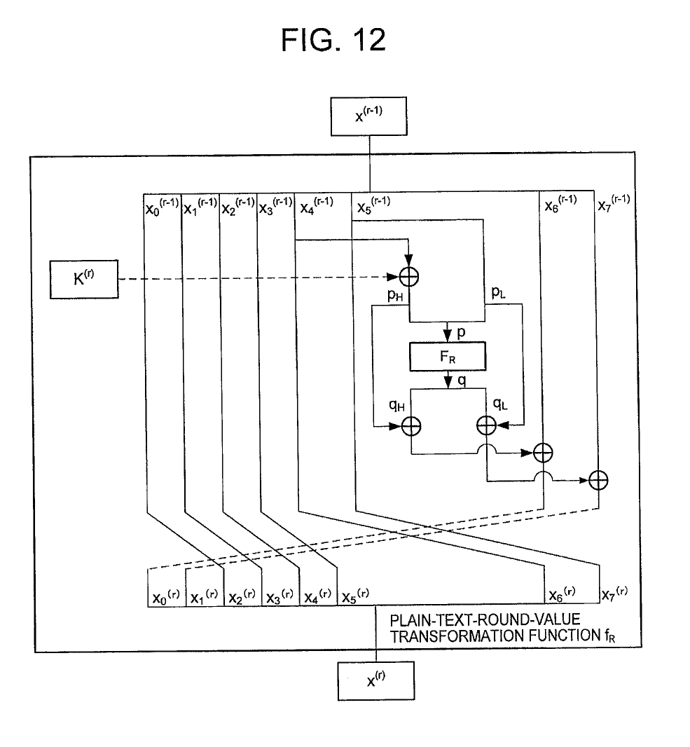

In the embodiments described above, although the plain-text-round-value transformation function ƒ_{R} is used, the present invention is not limited to such aspects, and any function which utilizes the function F_{R} as an F function may be used. For example, a plain-text-round-value transformation function ƒ_{R} such as the one illustrated in FIG. 12 (which shows a schematic diagram of a variant of the plain-text-round-value transformation function ƒ_{R}) may also be used.

In the plain-text-round-value transformation function ƒ_{R} illustrated in FIG. 12, a higher-order bits (here, 64 bits) value q_{H}(q_{H}=F_{R}(x₄^{(r-1)}XOR K^{(r)}, x₅^{(r-1)})_{H}) and a lower bits (here, 64 bits) value q_{L} (q_{L}=F_{R}(x₄^{(r-1)}XOR K^{(r}), x₅^{(r-1)})_{L}) are calculated from the the output value obtained as a result of inputting a value p into the function F_{R} which is one of the F functions. The value p is generated by combining a value p_{H} of the exclusive disjunction of the round constant K^{(r)} and x₄^{(r-1)} in the plain-text round value of the (r−1) round (in the case of r=0, the message block M′ᵢ), and a value p_{L} of x₅^{(r-1)} in the plain-text round value of the (r−1) round (in the case of r=0, the message block M′ᵢ).

Then, an exclusive disjunction of an exclusive disjunction of the value p_{H} and the value q_{H}, and x₆^{(r-1)} in the plain-text round value of the (r−1) round (in the case of r=0, the message block M′ᵢ) is calculated, and the calculated value is set to be x₀^{(r)} of the plain-text round value of the rth round.

Additionally, an exclusive disjunction of an exclusive disjunction of the value p_{L} and the value q_{L}, and x₇^{(r-1)} in the plain-text round value of the (r−1) round (in the case of r=0, the message block M′ᵢ) is calculated, and the calculated value is set to be x₁^{(r)} of the plain-text round value of the rth round.

By using a plain-text-round-value transformation function ƒ_{R} such as the one illustrated in FIG. 12, and by feed-forwarding an input to a F function into its output, exchangeability of a F function part can be modified.

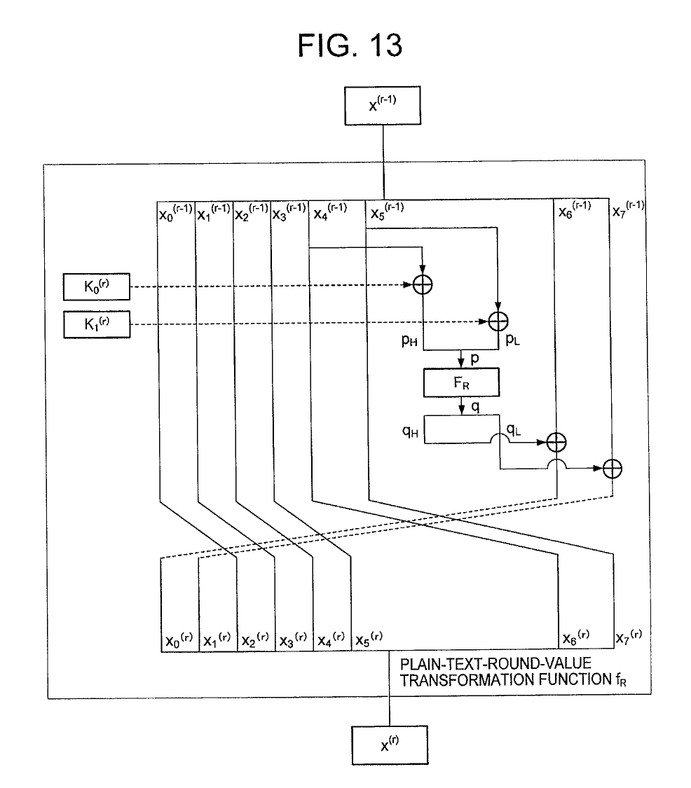

Furthermore, in place of a plain-text-round-value transformation function ƒ_{R} such as the one illustrated in FIG. 5, for example, the plain-text-round-value transformation function ƒ_{R} illustrated in FIG. 13 (which shows a schematic diagram of a variant of the plain-text-round-value transformation function ƒ_{R}) may be used.

In the plain-text-round-value transformation function ƒ_{R} illustrated in FIG. 13, a higher-order bits (here, 64 bits) value q_{H} (q_{H}=F_{R}(x₄^{(r-1)}XOR K₀^{(r)}, x₅^{(r-1)}XOR K₁^{(r)})_{H}) and a lower bits (here, 64 bits) value q_{L}(q_{L}=F_{R}(x₄^{(r-1)}XOR K^{(r)}, x₅^{(r-1)}XOR K₁^{(r)})_{L}) are calculated from the output value obtained by inputting a value p into the function F_{R} which is one of the F functions. The value p is generated by combining a value p_{H} of the exclusive disjunction of the round key K₀^{(r)} and x₄^{(r-1)} in the plain-text round value of the (r−1) round (in the case of r=0, the message block M′ᵢ), and a value p_{L} of the round key K₁^{(r)} and x₅^{(r-1)} in the plain-text round value of the (r−1) round (in the case of r=0, the message block M′ᵢ).

Note that the round key K₀^{(r)} uses the k₂^{(r)} in the key round value of the rth round, and that the round key K₁^{(r)} uses the k₃^{(r)} in the key round value of the rth round.

By using the plain-text-round-value transformation function ƒ_{R} illustrated in FIG. 13, the size of a round key can be more than doubled.

The specification and drawings are, accordingly, to be regarded in an illustrative rather than a restrictive sense. It will, however, be evident that various modifications and changes may be made thereto without departing from the spirit and scope of the invention as set forth in the claims.

What is claimed is:

1. A hash value generation device which splits the message into blocks of predetermined data length, transforms specific split data by a F function, among a plurality of split data which are generated by splitting the blocks, and generates a hash value of the message by using a block cipher having a shuffling process that calculates an exclusive disjunction between the transformed specific split data and other specific split data, comprising:
a control unit performing a transformation including at least a nonlinear transformation more than once by the F function.

2. The hash value generation device according to claim 1, wherein the F function performs a combined transformation of a nonlinear transformation, a byte permutation, and a matrix multiplication more than once.

3. The hash value generation device according to claim 2, wherein the combined transformation is performed four times.

4. The hash value generation device according to claim 2, wherein the nonlinear transformation performs a transformation by extracting transformed data corresponding to the pre-transformed data thereof from a predetermined substitution table.

5. The hash value generation device according to claim 2, wherein, in a matrix having pre-transformed data as its elements, the byte permutation performs a transformation which places respective elements contained in arbitrary columns into different columns respectively.

6. The hash value generation device according to claim 2, wherein the matrix multiplication multiplies a matrix having pre-transformed data as its elements by a transformation matrix, such that the number of non-zero elements among the respective elements contained in arbitrary columns of the matrix and the respective elements contained in the columns in the multiplied matrix corresponding to the arbitrary columns is more than or equal to a predetermined number.

7. The hash value generation device according to claim 6, wherein the predetermined number is 5 if the length of generated hash values is 512 bits.

8. The hash value generation device according to claim 6, wherein the predetermined number is 3 if the length of generated hash values is 256 bits.

9. A program making a computer to function as a hash value generation device, whereby the hash value generation device which splits the message into blocks of predetermined data length, transforms specific split data by a F function, among a plurality of split data which are generated by splitting the blocks, and generates a hash value of the message by using a block cipher having a shuffling process that calculates an exclusive disjunction between the transformed specific split data and other specific split data, wherein the program making the computer to function as:
controlling means for performing a transformation including at least a nonlinear transformation more than once by the F function.

10. The program according to claim 9, wherein the F function performs a combined transformation of a nonlinear transformation, a byte permutation, and a matrix multiplication more than once.

11. The program according to claim 10, wherein the combined transformation is performed four times.

12. The program according to claim 10, wherein the nonlinear transformation performs a transformation by extracting transformed data corresponding to the pre-transformed data thereof from a predetermined substitution table.

13. The program according to claim 10, wherein, in a matrix having pre-transformed data as its elements, the byte permutation performs a transformation which places respective elements contained in arbitrary columns into different columns respectively.

14. The program according to claim 12, wherein the matrix multiplication multiplies a matrix having pre-transformed data as its elements by a transformation matrix, such that the number of non-zero elements among the respective elements contained in arbitrary columns of the matrix and the respective elements contained in the columns in the multiplied matrix corresponding to the arbitrary columns is more than or equal to a predetermined number.

15. The program according to claim 14, wherein the predetermined number is 5 if the length of generated hash values is 512 bits.

16. The program according to claim 14, wherein the predetermined number is 3 if the length of generated hash values is 256 bits.

17. A hash value generating method performed by a hash value generation device whereby the hash value generation device which splits the message into blocks of predetermined data length, transforms specific split data by a F function, among a plurality of split data which are generated by splitting the blocks, and generates a hash value of the message by using a block cipher having a shuffling process that calculates an exclusive disjunction between the transformed specific split data and other specific split data, the method comprising the step of:
causing a control unit of the hash value generation device to perform a transformation including at least a nonlinear transformation more than once using the F function
